(19) United States
(12) Patent Application Publication
(10) Pub. No.: US 2026/0110897 A1
(43) Pub. Date: Apr. 23, 2026

(54) Diffraction Grating Design Techniques and Arrangements Using Sub-Wavelength Structures

(71) Applicant: COHERENT PHOTONICS LLC, Plainsboro, NJ (US)

(72) Inventors: Yakov SOSKIND, Plainsboro, NJ (US); Michael SOSKIND, Plainsboro, NJ (US); Vaibhav RATHORE, Marlborough, MA (US)

(21) Appl. No.: 19/315,078

(22) Filed: Aug. 29, 2025

Related U.S. Application Data
(63) Continuation-in-part of application No. 18/919,973, filed on Oct. 18, 2024.

(51) Int. Cl. G02B 27/00; G02B 5/18; G06F 30/20; G06F 119/18

(52) U.S. Cl. CPC G02B 27/0012; G02B 5/1809; G02B 5/1847; G06F 30/20; G06F 2119/18

(57) ABSTRACT

A sub-wavelength grating (SWG0 comprises two-dimensional arrays of sub-wavelength structures, where the length of each array equals the length of SWG period. Each array is defined as an arrangement of several sub-wavelength structures with different shapes, sizes, and/or spacings between one another. Array can be arranged as linear or two-dimensional arrangements of the sub-wavelength structures. The sub-wavelength structures' sizes and their positions within the arrays are optimized to introduce field coupling effects between the sub-wavelength structures within the arrays, resulting in that cannot be achieved as a combination of properties of individual sub-wavelength structures. Field coupling effects within the array of sub-wavelength structures play a very important role in achieving highly efficient SWGs that also satisfy manufacturability requirements.

### CROSS-REFERENCE TO RELATED APPLICATION

This application is a continuation-in-part of U.S. Ser. No. 18/919,973, filed Oct. 18, 2024, entitled “DIFFRACTION GRATING DESIGN TECHNIQUES AND ARRANGEMENTS USING SUB-WAVELENGTH STRUCTURES”, the contents of which are incorporated herein by reference.

### GOVERNMENT FUNDING

This invention was made with government support under NSF SBIR Phase I Grant No. 2506374. The government has certain rights in the invention.

### SUMMARY

Diffraction gratings containing sub-wavelength structures, and design techniques for achieving high diffraction efficiencies and manufacturability for such elements, are provided. Diffraction gratings containing sub-wavelength structures represent two-dimensional periodic arrays of sub-wavelength structures with different shapes and sizes. Selection of a particular arrangement of sub-wavelength structures within the arrays considers both diffraction efficiency and manufacturability of the gratings.

### FIELD OF THE INVENTION

The present invention relates to optical design of diffractive optical elements. More specifically, the invention relates to design and manufacturability of diffraction gratings containing arrays of sub-wavelength structures, also referred to as sub-wavelength gratings (SWGs), where arrangements of sub-wavelength structures within the arrays are optimized with respect to the gratings' performance and manufacturability.

### BACKGROUND OF THE INVENTION

Diffractive gratings are periodic structures that constitute an important class of diffractive optical elements, and are used in a variety of optical devices and photonics instruments, including spectrometers, tunable laser systems, laser pulse compressors, wavelength division multiplexers, etc. With the reduction in gratings' periods, traditional diffraction gratings with blazed profiles and their multi-step binary approximations become less efficient, so that a significant fraction of the incident light is dispersed into spurious diffraction orders outside of the working diffraction order. A reduction in diffraction efficiencies occurs in the “rigorous diffraction domain”, when the gratings' periods become small, satisfying the relation d≤10λ, where d is the grating period, and λ is the operating wavelength.

Sub-wavelength gratings (SWGs) have been developed to improve the diffraction efficiency of gratings with smaller periods. The gratings are composed of periodic arrangements of sub-wavelength structures and can be fabricated using well established and scalable processes, such as photolithography or nano-imprint lithography.

U.S. Pat. No. 9,103,973 “Sub-Wavelength Grating-Based Optical Elements” describes polarization insensitive SWGs composed of a two-dimensional array of sub-wavelength structures periodically arranged based on a lattice constant that defines a spacing grid between the sub-wavelength structures. The lattice constant needs to satisfy a no-scattering limit given by the following equation:

$$Λ < \frac{2}{\sqrt{3}} \frac{λ}{{n}_{s}} \qquad ( 1 )$$

In practical applications, SWGs are polarization insensitive only within the so called “scalar diffraction domain”, when the grating's period d is more than an order of magnitude larger than the operating wavelength λ, i.e. when

$$d / λ > 10 \qquad ( 2 )$$

The definition of the scalar diffraction domain is found, for example, on page 73 of the “Field Guide to Diffractive Optics”, SPIE Press, 2011. For gratings within the rigorous diffraction domain, when the period d is relatively small and the inequality (2) is no longer valid, the gratings' performance is no longer polarization insensitive, and the gratings' diffraction efficiency will depend on the polarization state of the incident light. In addition, selecting the lattice constant A to satisfy the non-scatter limit (Equation 1) within the rigorous domain would not be sufficient for achieving high diffraction efficiencies of the SWGs. Therefore, additional relations between the sub-wavelength structures need to be found to define SWGs with high diffraction efficiencies.

U.S. Pat. No. 10,459,258 “Meta Optical Device and Method of Designing the Same” describes the design process of SWGs with sub-wavelength structures having cylindrically-shaped cross-sections arranged along the grating's surface on a constant grid that defines the lateral placement of the sub-wavelength structures. It employs the periodic cell approximation (PCA) to define dimensions of the sub-wavelength structures that will produce the desired phase delay values across the meta-surface. The PCA implies that the phase delays produced by the individual sub-wavelength structures can be obtained from the phase delays produced by periodic arrays of identically shaped sub-wavelength structures. The PCA approach is also valid primarily within the scalar diffraction domain, as defined by equation (2).

It was found that meta-surface structures derived using the PCA approach do not yield high diffraction efficiencies within the rigorous domain, when the gratings' periods become smaller than d<10λ, and especially when d<5λ. Neither the fixed lattice constant approach, nor the PCA approach will result in SWGs that will produce high diffraction efficiencies. The two techniques also do not address the manufacturability of SWGs. Therefore, it is important to establish alternative, more efficient SWG structures within the rigorous domain, with periods d<10λ, and to develop design techniques that alleviate deficiencies of the previously established gratings' designs based on PCA or utilizing fixed lattice constants. It is also desirable to develop manufacturable SWGs that can be produced using established fabrication techniques.

### SUMMARY OF THE INVENTION

In view of the foregoing, one object of the present invention is to provide SWG solutions and associated design techniques that result in high diffraction efficiency SWGs.

Another object of the present invention is to provide high diffraction efficiency SWGs that can be designed to work with un-polarized light, or can be tailored to work with a particular polarization state of light.

Still another object of the present invention is to provide SWG design techniques that yield higher diffraction efficiencies as compared to PCA-based solutions, or solutions defined based on fixed lattice constant approach.

Still another object of the present invention is to provide high efficiency SWG designs that are manufacturable based on established fabrication techniques.

SWGs of the present invention are composed of two-dimensional arrays of sub-wavelength structures, where the length of each array equals the length of SWG period. Each array is defined as an arrangement of several sub-wavelength structures with different shapes, sizes, and spacings between one another. Array can be arranged as linear or two-dimensional arrangements of the sub-wavelength structures. The sub-wavelength structures' sizes and their positions within the arrays are optimized to introduce field coupling effects between the sub-wavelength structures within the arrays, and result in the arrays' properties that cannot be achieved as a combination of properties of individual sub-wavelength structures. For example, optimized arrays of sub-wavelength structures produce more efficient SWG solutions than respective SWG designs composed of individual sub-wavelength structures designed based on the PCA approach or based on the fixed lattice constant approach, when coupling effects between different sub-wavelength structures within the arrays are not controlled. Field coupling effects within the array of sub-wavelength structures play a very important role in achieving highly efficient SWGs that also satisfy manufacturability requirements.

The design technique of the present invention is based on defining multiple alternative SWG solutions composed of arrays with different arrangements of sub-wavelength structures and different numbers of sub-wavelength structures within the arrays, optimizing performance of these solutions, and selecting solutions that have the best performance while also satisfying manufacturability requirements. FIG. 1 presents a flow diagram 10 of the design technique in accordance with the present invention. The design technique starts with the analysis 15 of the SWG requirements, including the grating's diffractive properties, such as the gratings' period and the desired output energy distributions within the working diffraction orders. SWG requirements may also include operating wavelengths, angles of incidence and restrictions to the amounts of light diffracted into the spurious diffraction orders, as well as fabrication considerations, such as the minimum feature sizes of the sub-wavelength structures, and the minimum gaps between the sub-wavelength structures. Analysis 15 of the SWG requirements is followed by selection 20 of the SWG substrate and the grating's layer materials and thicknesses. The grating layer defines the height of the sub-wavelength structures within the arrays. Next, the sub-wavelengths structures are arranged 25 into array layouts that contain different numbers and different spatial arrangements of the sub-wavelength structures. The arrays have a length and a width, where the length corresponds to the grating periodicity along one direction and where the width corresponds to the arrays' periodicity in the orthogonal direction. The grating's optical performance, i.e. energy distribution within different diffraction orders, is based on the arrays' layouts and is simulated using rigorous electromagnetic solvers for Maxwell's equations, such as the Rigorous Coupled Wave Analysis (RCWA) and Finite Difference Time Domain (FDTD) techniques. When using RCWA for simulating the grating's optical performance, the arrays are periodically spaced in two orthogonal directions, along the array's length and width. When using FDTD for the grating's optical performance, periodic boundary conditions are applied to the arrays' layouts. The multiple SWG solutions containing arrays of sub-wavelength structures with different numbers and spatial arrangements are optimized 30 using advanced machine learning techniques by adjusting the shapes, sizes and distances between the individual sub-wavelength structures within the arrays. Optimization techniques may include adjoint optimization, simulated annealing, gradient decent, neural networks, genetic algorithms, or other advanced multi-parametric optimization algorithms. Optimized SWGs will provide a closest match to the required output energy distributions within the working diffraction orders for each of the alternative array designs. Resulting SWGs are analyzed 35 with respect to their performance, i.e. the output energy distribution within the working diffraction orders, and manufacturability, i.e. an assessment of the minimum feature sizes of the sub-wavelength structures, such as the smallest cross-sections of the structures, and the minimum gaps between the sub-wavelength structures within the arrays. During the analysis step, the grating solutions can be evaluated with respect to their sensitivity to changes in sub-wavelength structures' shapes and sizes, where the changes are typical to the specific fabrication techniques, such as photo-lithography or nano-imprint lithography. For arrays containing sub-wavelength structures with feature sizes and gaps below the minimum values defined by the manufacturing processes, modifications 40 of the arrays' structures are implemented. For example, manufacturing constraints can be applied to the arrangements of the sub-wavelength structures, restricting the feature sizes and gaps to the minimum values defined by the manufacturing processes. Alternatively, sub-wavelength structures that do not satisfy the manufacturability criteria can be excluded from the arrays. Alternatively, sub-wavelength structures can be also re-arranged within the arrays to increase the gaps between the sub-wavelength structures. That includes implementing lateral offsets of some sub-wavelength structures from the rest of the sub-wavelength structures within the arrays in the direction of the arrays' widths, i.e. in the direction orthogonal to the grating's period. The arrays' modifications 40 can be followed by another optimization cycle 30 and analysis cycle 35, yielding the best performing solutions in the presence of manufacturing limitations and constraints. Meta-grating selection 45 with the best performance and compliance with manufacturability requirements is performed as the final step in the design process.

The presented design technique can be applied towards the design of polarization-insensitive gratings, i.e. SWGs that have high diffraction efficiencies in both polarization states, as well as gratings that are optimized for the highest diffraction efficiency only for a particular polarization state of light. Presented design techniques can be also applied to SWGs composed of different sub-wavelength structures, including sub-wavelength islands or sub-wavelength holes of different shapes and sizes, with different wall slope angles and heights. In the simplest case, sub-wavelength structures are represented by cylinders with circular or elliptical cross-sections.

According to the present invention, several SWG designs with the same grating's period d and different spatial arrangements and different numbers N of the sub-wavelength structures forming arrays within the grating's period are optimized and evaluated using machine learning techniques to yield the best performing and manufacturable solution. Manufacturability can be evaluated by applying specific design rules, such as the minimum gap values between the sub-wavelength structures and their minimum cross-section sizes. The resulting SWG designs contain an optimum number of sub-wavelengths structures within the grating's period, with specific, optimized nanostructure shapes, lateral distances between the sub-wavelength structures and their cross-sectional profiles. Selected SWG solutions will satisfy design rules imposed by manufacturing considerations, and will have the best overall performance, i.e. the highest diffraction efficiencies in the working diffraction orders, manufacturable arrangements of the sub-wavelength structures, along with acceptable sensitivity to fabrication tolerances.

While optimized SWG arrays in the exemplary embodiments are designed to diffract most of the incident light into the transmitted 1^{st} diffraction order, SWGs can also be optimized as beam-splitters, when specific amounts of the incident light are distributed between a variety of transmitted or reflected diffraction orders, including the 0^{th} order. While the exemplary embodiments are designed for light incident at normal angles of incidence, those skilled in the art can apply the present invention to design efficient SWGs operating at non-zero angles of incidence. Optimized sub-wavelength structures in the exemplary embodiments of the present invention represent sub-wavelength structures with circular and elliptical cross-sections, with different sizes and different ellipticities. Alternative geometries of the sub-wavelength structures with differently shaped cross-sections, such as polygonal geometries and free-form-shaped islands can also be used to form the arrays. Free-form sub-wavelength structures with cross-sections that have a single axis of symmetry, or without symmetry, can be also employed to form the arrays.

Objectives of the present invention are achieved in accordance with the following design examples, as will be explained in detail in the following illustrative embodiments.

The features of the present invention, including the construction and operational details of the illustrative embodiments, will be described in reference to the accompanying drawings.

### BRIEF DESCRIPTION OF THE DRAWINGS

FIG. 1 shows a process flow diagram of SWGs' design technique in accordance with the present invention.

FIG. 2 schematically shows the side view of a sub-wavelength structure used in SWGs designed in accordance with the periodic cell approximation technique.

FIG. 3 schematically shows the top view of a linear array of sub-wavelength structures comprised of 6 cylindrical sub-wavelength posts with circular cross-sections.

FIG. 4 schematically shows the top view of a SWG composed of a two-dimensional arrangement of periodically spaced arrays, each comprised of 6 cylindrical sub-wavelength posts with circular cross-sections.

FIG. 5 presents a comparison between the diffraction efficiencies of SWGs optimized for un-polarized light, containing arrays with different numbers of cylindrical sub-wavelength posts with circular cross-sections.

FIG. 6 presents a comparison between the diffraction efficiencies of SWGs optimized for un-polarized light, containing arrays with different numbers of equally-spaced cylindrical sub-wavelength posts with elliptical and circular cross-sections.

FIG. 7 presents a comparison between the diffraction efficiencies of SWGs optimized for un-polarized light, containing arrays with different numbers of equally-spaced cylindrical sub-wavelength posts with circular cross-sections and cylinders with variable spacings and elliptical cross-sections.

FIG. 8 presents transmission and phase delay characteristics for cylindrical sub-wavelength structures with circular cross-sections made of Si and designed using PCA.

FIG. 9 shows the phase distribution in the X-Z plane after light propagation through the optimized array of sub-wavelength structures.

FIG. 10 schematically shows the top view of a SWG array comprised of 5 cylindrical sub-wavelength posts with elliptical cross-sections and variable spacings.

FIG. 11 schematically shows the top view of a SWG composed of a two-dimensional arrangement of periodically spaced arrays comprised of 5 cylindrical sub-wavelength posts with elliptical cross-sections spaced at non-equal distances.

FIG. 12 schematically shows the top view of a SWG array comprised of 6 cylindrical sub-wavelength posts with elliptical cross-sections and spaced at non-equal distances.

FIG. 13 schematically shows the top view of a SWG composed of a two-dimensional arrangement of periodically spaced arrays comprised of 6 cylindrical sub-wavelength posts with elliptical cross-sections spaced at non-equal distances.

FIG. 14 schematically shows the top view of a SWG array comprised of 5 cylindrical sub-wavelength posts with elliptical cross-sections, spaced at non-equal distances and containing a topological defect.

FIG. 15 schematically shows the top view of a SWG composed of a two-dimensional arrangement of periodically spaced arrays with topological defects comprised of 5 cylindrical sub-wavelength posts with elliptical cross-sections and spaced at non-equal distances containing a topological defect.

FIG. 16 presents a comparison between the diffraction efficiencies of SWGs optimized for p-polarized light and containing arrays with different numbers of cylindrical sub-wavelength posts.

FIG. 17 presents a comparison between the diffraction efficiencies of SWGs optimized for s-polarized light and containing arrays with different numbers of cylindrical sub-wavelength posts.

FIG. 18 schematically shows the top view of a two-dimensional SWG array with lateral offsets of sub-wavelength structures comprised of 8 cylindrical sub-wavelength posts with elliptical cross-sections and variable spacings.

FIG. 19 schematically shows the top view of a SWG composed of a two-dimensional arrangement of periodically spaced arrays with lateral offsets of sub-wavelength structures.

FIG. 20 schematically shows the top view of a two-dimensional SWG array with lateral offsets of sub-wavelength structures comprised of 9 cylindrical sub-wavelength posts with elliptical cross-sections and variable spacings.

FIG. 21 schematically shows the top view of a two-dimensional SWG array with lateral offsets of sub-wavelength structures comprised of 6 cylindrical sub-wavelength posts with elliptical cross-sections, variable spacings, and containing a topological defect.

FIG. 22 schematically shows the top view of a two-dimensional SWG array with lateral offsets of sub-wavelength structures comprised of 7 cylindrical sub-wavelength posts with elliptical cross-sections and variable spacings.

FIG. 23 shows the top view of a SWG unit cell composed of 6 cylindrical sub-wavelength posts with circular cross-sections.

FIG. 24 schematically shows the top view of a two-dimensional SWG array composed of SWG unit cells containing 6 cylindrical sub-wavelength posts with circular cross-sections.

FIG. 25 shows the top view of a first optimized SWG unit cell composed of 6 sub-wavelength posts with freeform-shaped cross-sections.

FIG. 26 schematically shows the top view of a first optimized SWG two-dimensional array composed of SWG unit cells containing 6 sub-wavelength posts with freeform-shaped cross-sections.

FIG. 27 shows the top view of a second optimized SWG unit cell composed of 6 sub-wavelength posts with freeform-shaped cross-sections.

FIG. 28 schematically shows the top view of a second optimized SWG two-dimensional array composed of SWG unit cells containing 6 sub-wavelength posts with freeform-shaped cross-sections.

FIG. 29 shows the top view of a third optimized SWG unit cell composed of 6 sub-wavelength posts with freeform-shaped cross-sections.

FIG. 30 schematically shows the top view of a third optimized SWG two-dimensional array composed of SWG unit cells containing 6 sub-wavelength posts with freeform-shaped cross-sections.

FIG. 31 shows the top view of a fourth optimized SWG unit cell composed of 6 sub-wavelength posts with freeform-shaped cross-sections.

FIG. 32 schematically shows the top view of a fourth optimized SWG two-dimensional array composed of SWG unit cells containing 6 sub-wavelength posts with freeform-shaped cross-sections.

FIG. 33 shows the top view of an SWG unit cell composed of 6 unequally-spaced sub-wavelength posts with elliptically-shaped cross-sections.

FIG. 34 schematically shows the top view of a two-dimensional SWG array composed of the unit cells containing 6 unequally-spaced sub-wavelength posts with elliptical cross-sections.

FIG. 35 shows the top view of an optimized exemplary SWG unit cell composed of 6 sub-wavelength posts with freeform-shaped cross-sections.

FIG. 36 schematically shows the top view of a two-dimensional SWG array composed of the unit cells containing 6 sub-wavelength posts with freeform-shaped cross-sections.

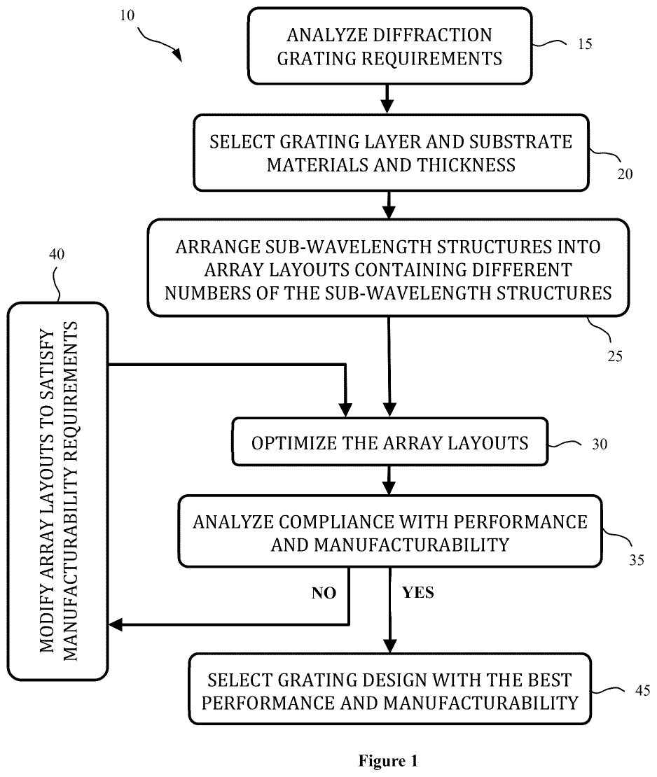

### DETAILED DESCRIPTION

The present invention is further described in detail in the form of the specific embodiments. However, the present invention is not limited to only the specific embodiments described herein, and can be employed with a broad range of modifications to the disclosed embodiments. For example, different types of materials can be used to fabricate SWGs, including the substrate, the sub-wavelength structures, an optional etch stop layer, anti-reflection coatings, overcoat layer material, etc. Materials' selection will affect the optimum number of sub-wavelength structures within the SWG periods, as well as the shapes and sizes of the structures. The sub-wavelength structures can be also encapsulated in a lower refractive index material, rather than being surrounded by air, to protect them from contamination and damage. Encapsulation may also influence the number of sub-wavelength structures within the SWG periods, the sub-wavelength structures' heights, cross-sectional shapes and sizes. The SWG design technique described herein can be used to produce optimized diffraction gratings tailored for operation over different spectral regions and wavelengths of interest, especially SWGs with smaller periods d, satisfying the relation d≤10λ, where λ is the operating wavelength.

Different arrangements of sub-wavelength structures into arrays can be made, including arrays with different numbers, spacings, and sizes of the constituent structures. The sub-wavelength structures can be arranged in linear arrays or as arrays where part of the sub-wavelength structures is laterally offset from the rest of the sub-wavelength structures within the array. The number of laterally offset sub-wavelength structures can differ between different arrays. The lateral offset values of the sub-wavelength structures within arrays can also vary between different arrays. The largest lateral offset of a sub-wavelength structure is half the array width.

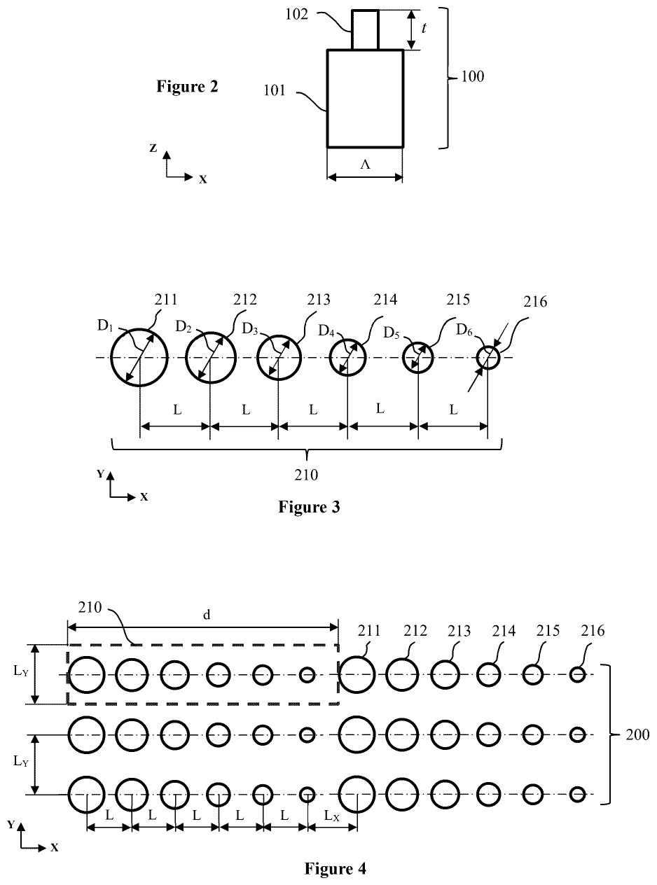

FIG. 2 presents a side view of a typical sub-wavelength block 100 used to construct meta-surfaces in accordance with U.S. Pat. No. 10,459,258 “Meta Optical Device and Method of Designing the Same”. It consists of a supporting base 101 and a sub-wavelength meta-structure 102. U.S. Pat. No. 10,459,258 defines transmission and phase delay characteristics produced by specific sub-wavelength blocks 100 based on the PCA approach, when transmission and phase delay characteristics of a single sub-wavelength block are inferred from the respective transmission and phase delay characteristics of a periodic array of these blocks, equally spaced in two orthogonal directions. Transmission and phase delay characteristics are calculated using the PCA approach for the specific values of wavelength A, meta-structure height t, and lateral spacing of the blocks 100 as a function of the structure cross-section diameter.

U.S. Pat. No. 9,103,973 “Sub-Wavelength Grating-Based Optical Elements” defines alternative designs of SWGs based on constant spacing between sub-wavelength structures, referred to as a lattice constant A. Cross-sections of the sub-wavelength structures spaced at the lattice constant distances have different diameters. In accordance with the U.S. Pat. No. 9,103,973, the lattice constant A is selected based on a non-scatter limit, when only the 0^{th} diffraction orders in transmission and reflection exist. FIG. 2 of U.S. Pat. No. 9,103,973 shows reflective, transmissive and phase characteristics of cylindrical sub-wavelength posts spaced at a constant distance of 475 nm while varying the duty cycle of the posts between 0% to 100%. Duty cycle of the sub-wavelength structures is selected from within the range where the structures produce high transmission, while the transmitted phase exhibits a smooth variation.

The solutions defined in U.S. Pat. Nos. 9,103,973 and 10,459,258 do not result in high diffraction efficiency manufacturable solutions, especially for gratings with periods d satisfying the relation d≤101, where λ is the operating wavelength. In accordance with the present invention, the size of the sub-wavelength structures within SWG arrays and the distances between the individual sub-wavelength structures within SWG arrays are adjusted to induce controlled coupling of electromagnetic fields between the sub-wavelength structures within the SWG arrays. Controlled field coupling between the sub-wavelength structures within SWG arrays results in transmission characteristics and phase properties of the arrays that differ from arrays of sub-wavelength structures that are designed based on PCA approach or constant lattice approach, when the field coupling effects between different sub-wavelength structures within the entire arrays are not being accounted for. The height of sub-wavelength structures within the arrays can be also adjusted to further enhance controlled coupling of electromagnetic fields between the sub-wavelength structures.

FIG. 3 schematically shows the top view of a linear array 210 composed of 6 sub-wavelength cylindrical posts 211 through 216 defining a SWG's period d. The sub-wavelength posts 211 through 216 have circular cross-sections and are located at equal distances L from each other along the X-axis. The sub-wavelength posts 211 through 216 have respective cross-section diameters D₁ through D₆. The cross-section diameters D₁ through D₆ and the spacing value L are selected to induce controlled electro-magnetic field coupling within the array. Due to the field coupling effects between the sub-wavelength posts within the array, optical properties of the array, optimized as an ensemble of inter-coupled sub-wavelength posts, are different from the optical properties of the array defined based on optical properties of the individual sub-wavelength posts, when the field coupling effects between different sub-wavelength structures within the array are not taken into account. For example, diffraction efficiencies of the individual sub-wavelength structures calculated using the PCA approach are polarization independent, i.e. diffraction efficiencies of linearly polarized light are the same for p-polarized and for s-polarized light. When the sub-wavelength structures are arranged into arrays with controlled field coupling, diffraction efficiencies of the arrays are no longer polarization-independent and exhibit different diffraction efficiencies for p-polarized and s-polarized states of light.

FIG. 4 schematically shows the top view of SWG 200 composed of a two-dimensional arrangement of periodically spaced arrays 210, each array comprised of 6 cylindrical sub-wavelength posts with circular cross-sections, as shown in FIG. 3. Array 210 has wavelength d oriented along the X-axis and width L_{Y} oriented along the Y-axis. The length d of the array also defines the period of the SWG, and the width L_{Y} also defines lateral arrays' spacing within the SWGs. The array of sub-wavelength posts 210 is outlined in FIG. 4 by a dashed line. The distance L_{X} between neighboring sub-wavelength posts of two adjacent arrays equals the distance L between the sub-wavelength posts within the arrays, i.e. L_{X}=L. It was found that neither PCA approach nor the constant lattice A approach would yield the most efficient and manufacturable SWG solutions in the rigorous diffraction domain, when the gratings periods d are smaller than 10 wavelengths of light A, i.e. when d/λ<10. Field coupling effects between the neighboring sub-wavelength structures within the rigorous diffraction domain play an important role in controlling SWG's performance, and cannot be ignored.

The present invention demonstrates SWG solutions with improved diffraction efficiencies in the rigorous diffraction domain when the gratings periods d are smaller than 10 waves of light 1 by providing optimized spatial arrangements and shapes of the sub-wavelength structures and producing controlled coupling between the structures. To establish the most efficient and manufacturable designs, several SWG arrangements with different numbers of sub-wavelength structures contained within the grating's period are optimized using machine learning techniques and evaluated with respect to their compliance with performance and manufacturability requirements. For each selected number of sub-wavelength structures contained within the arrays, spacings between the sub-wavelength structures and cross-sectional shapes of the individual sub-wavelength structures are adjusted during the optimization process to yield the highest possible diffraction efficiencies. In addition, lateral spacings between array within the SWG assemblies are also adjusted during the optimization process to yield the highest possible diffraction efficiencies. In general, the lateral spacings between arrays of sub-wavelength structures within SWGs differ from the average spacings of the sub-wavelength structures within the arrays. From the optimized SWG arrangements with different numbers of the sub-wavelength structures, solutions with the highest diffraction efficiencies that also satisfy manufacturability requirements are selected. Optimized SWG arrangements that fail to satisfy manufacturability requirements can be modified and re-optimized to yield efficient and manufacturable SWGs, as will be explained in detail in the following embodiments.

### Embodiment 1

The first embodiment demonstrates the design and optimization process for SWGs intended to operate with un-polarized light at normal incidence. The SWGs are composed of Si sub-wavelength posts fabricated onto a SiO₂ substrate and have the grating period of d=3.459 μm that also corresponds to the length of the gratings' array. The thickness of the Si layer that defines the height of the Si posts is t=0.8 μm. The SWG is designed for operation at normal incidence and a wavelength of λ=1.55 μm. The grating's periods d is approximately 2.23 times larger than the wavelength of light λ, i.e.d≈2.231.

For a grating with substrate refractive index nₛ=1.45 and operational wavelength λ=1.55 μm, the no-scattering condition (1) is satisfied when the lattice constant Λ, defining the upper limit to the distances between the neighboring posts, is calculated to be 1.234 μm. Therefore, for the SWG with X-axis periodicity d=3.459 μm, the minimum number of sub-wavelength posts within the grating's period d and satisfying the no-scattering condition (1) equals to 3.

Multiple arrays of sub-wavelength posts corresponding to SWGs with a periodd=3.459 μm and containing different numbers of the sub-wavelength posts have been optimized with the goal of maximizing diffraction efficiencies in the 1^{st} diffraction order. The sub-wavelength posts' spacing within the arrays and the shapes of the individual sub-wavelength posts within the array have been adjusted to yield the highest possible diffraction efficiencies.

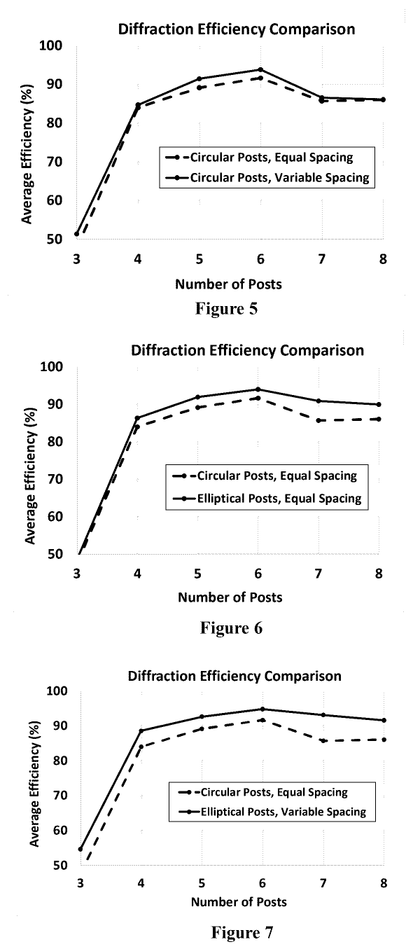

FIGS. 5 through 7 show diffraction efficiencies of SWG arrays containing N sub-wavelength posts, where N ranges from 3 to 8. FIG. 5 presents diffraction efficiencies of optimized SWGs containing different numbers of sub-wavelength posts with circular cross-sections within the grating's period d. Diffraction efficiencies shown in FIG. 5 are defined as the average of diffraction efficiencies for s-polarized and p-polarized light. The dotted line represents diffraction efficiencies of optimized SWGs composed of arrays comprising equally spaced sub-wavelength posts with circular cross-sections, when only the posts' diameters have been adjusted during the optimization process to achieve inter-coupling effects that resulted in the highest possible diffraction efficiencies. The solid line represents diffraction efficiencies of optimized SWGs composed of arrays comprising sub-wavelength posts with variable spacings and circular cross-sections, after the spacings between the sub-wavelength posts and the sub-wavelength posts' diameters have been adjusted to achieve optimized inter-coupling effects that resulted in the highest diffraction efficiencies of the SWGs. By adjusting the lateral spacings between the sub-wavelength posts within the arrays, an increase in the average diffraction efficiency of up to 3% was achieved.

FIG. 6 presents the averaged diffraction efficiencies of optimized SWGs containing different numbers of sub-wavelength posts with circular and elliptical cross-sections within the grating's period d. The dotted line represents the diffraction efficiencies of optimized SWGs composed of arrays with equally-spaced sub-wavelength posts having circular cross-sections, when only the posts' diameters have been adjusted during the optimization process to achieve inter-coupling effects that resulted in the highest possible diffraction efficiencies for each of the array type. The solid line represents diffraction efficiencies of optimized SWGs composed of arrays comprising equally spaced sub-wavelength posts with elliptical cross-sections, when only the elliptical posts' x- and y-dimensions have been adjusted during the optimization process to achieve inter-coupling effects that resulted in the highest possible diffraction efficiencies for each of the SWGs. By adjusting the x- and y-dimensions of the elliptical posts within the arrays, an increase in average diffraction efficiencies for the two polarization states was achieved. The largest relative increase in the averaged diffraction efficiency of 6.1% was achieved when the number of sub-wavelength posts was N=7.

FIG. 7 presents the averaged diffraction efficiencies of optimized SWGs containing different numbers of sub-wavelength posts with circular and elliptical cross-sections within the grating's period d. The dotted line represents the diffraction efficiency of the optimized SWGs composed of arrays with equally-spaced sub-wavelength posts having circular cross-sections, when only the posts' diameters have been adjusted during the optimization process to achieve inter-coupling effects that resulted in the highest possible diffraction efficiencies for each of the array types. The solid line represents the diffraction efficiency of the optimized SWGs composed of arrays with non-equally spaced sub-wavelength posts with elliptical cross-sections, when the spacing between the neighboring posts and the x- and y-dimensions of the posts have been adjusted during the optimization process to achieve inter-coupling effects that resulted in the highest possible diffraction efficiencies for each of the SWGs. By adjusting the x- and y-dimensions of the elliptical posts and the posts' lateral spacings within the arrays, the most significant increase in the averaged diffraction efficiencies for the two polarization states was achieved. The largest relative increase in the averaged diffraction efficiency of 8.7% was achieved when the number of sub-wavelength posts was N=7.

The heights of the Si sub-wavelength posts can also be made adjustable during the optimization process to further increase diffraction efficiencies of the optimized arrays.

In accordance with the present invention, multiple SWG designs containing arrays with different numbers N of the sub-wavelength posts and corresponding to a grating period of d=3.459 μm are optimized and evaluated with respect to their diffraction efficiencies and manufacturability.

As shown in FIG. 5, in the case of arrays composed of equally-spaced sub-wavelength posts with circular cross-sections, the highest averaged diffraction efficiency of 91.6% is achieved when the number of sub-wavelength posts contained within the arrays was N=6. In that case, the distance between the sub-wavelength posts within the array along the X-axis is L_{X}=576.5 nm or 0.37λ. Optimized lateral spacing between the neighboring arrays within the SWG in the Y-axis direction is equal to L_{Y}=795 nm or 0.51λ, i.e. is about 38% larger than the distance between the sub-wavelength posts within the array in the X-axis direction. Prescription details of the optimized array of sub-wavelength structures with an average diffraction efficiency in the 1^{st} diffraction order of 91.6%, containing N=6 equally-spaced sub-wavelength posts having circular cross-sections and shown in FIG. 3 is listed in Table 1. The s-polarized and p-polarized efficiencies for the structure are 90.7% and 92.6%, respectively. Table 1 also includes transmission and phase delay characteristics of the individual sub-wavelength posts 211 through 216 when calculated using the PCA approach.

TABLE 1

| Post designation | 211 | 212 | 213 | 214 | 215 | 216 |
|---|---|---|---|---|---|---|
| Diameter (nm) | 419 | 377 | 357 | 334 | 303 | 188 |
| Ellipticity, η | 1.0 | 1.0 | 1.0 | 1.0 | 1.0 | 1.0 |
| X-axis Spacing (nm) | 576.5 | 576.5 | 576.5 | 576.5 | 576.5 | 576.5 |
| PCA-based | 0.827 | 0.855 | 0.913 | 0.975 | 0.997 | 0.974 |
| Transmission | | | | | | |
| PCA-based | 236.0 | 194.3 | 166.9 | 130.7 | 91.1 | 21.8 |
| Phase (deg.) | | | | | | |

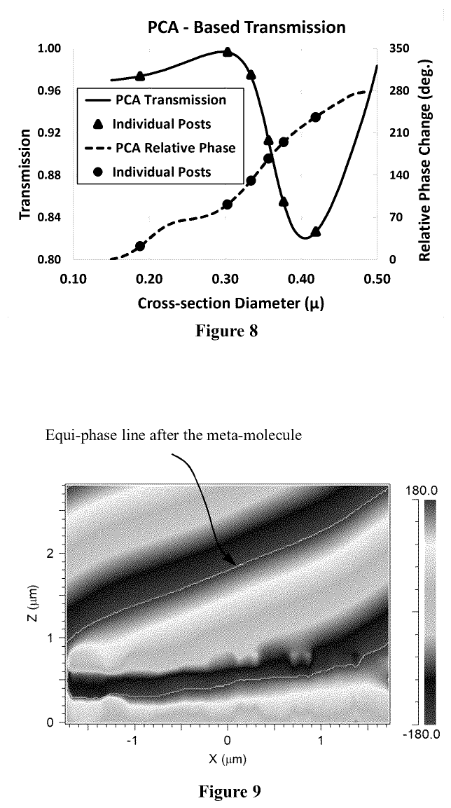

In the presence of field coupling effects between sub-wavelength posts within the array, the array properties differ from the array properties inferred from combination of individual sub-wavelength posts with properties defined using the PCA approach or with the fixed lattice constant approach. FIG. 8 presents transmission and phase delay characteristics defined using the PCA approach for arrays of cylindrical sub-wavelength posts with circular cross-sections made of Si, periodically spaced in the X-axis and Y-axis directions by 576.5 nm, or 0.37λ from each other, and with heights t=0.8 μm. The solid line in FIG. 8 corresponds to transmission characteristics produced by sub-wavelength posts as their cross-section diameter changes from 0.15 μm to 0.5 μm. The dashed line in FIG. 8 corresponds to the phase characteristics produced by sub-wavelength posts as their cross-section diameter changes from 0.15 μm to 0.5 μm. Triangular symbols in FIG. 8 represent transmission characteristics of the individual sub-wavelength posts 211 through 216 calculated using the PCA approach and shown in Table 1. Circular symbols in FIG. 8 represent relative phase characteristics of the individual sub-wavelength posts 211 through 216 calculated using the PCA approach. The maximum phase difference within the array of sub-wavelength structures in Table 1, calculated using the PCA approach, is defined as the phase difference between the sub-wavelength post 211 with a cross-section diameter of 419 nm and the sub-wavelength post 216 with a cross-section diameter of 188 nm. That phase difference of 214.2 degrees, or 1.19π radians, is only 59.5% of the required 2π phase transition range that needs to be produced over each grating's period in the scalar diffraction domain using PCA or fixed lattice constant approach. Furthermore, phase increments produced by equally-spaced sub-wavelength posts using PCA technique are different from the phase increments of the array with controlled field coupling between the sub-wavelength posts. It should also be noted that using the PCA technique, the expected SWG performance is polarization independent, while the grating's performance obtained using controlled coupling within the arrays depends on the polarization state of the diffracted light. That confirms that the field coupling effects within the arrays of sub-wavelength structures are playing an important role in defining their diffractive properties, end therefore need to be taken into account during the SWG design process.

FIG. 9 shows phase formation of the coupled optical field in the X-Z plane as light propagates through the optimized array of sub-wavelength structures with prescription details defined in Table 1. The continuous equiphase line at the output of the optimized array of sub-wavelength structures in FIG. 9 corresponds to the SWG wavefront tilt associated with diffraction into the 1^{st} order. FIG. 9 shows that array of sub-wavelength posts with optimized coupling produces about 90% of the required 2π phase transition range, significantly exceeding the value of 59.5% predicted by the PCA approach.

From several optimized arrays of sub-wavelength structures, the most efficient designs that satisfy the manufacturability requirements were selected. The largest absolute diffraction efficiencies of 92.6%, 94.8% and 93.1%, defined as the averaged diffraction efficiencies for the two orthogonal polarization states, are achieved for N=5, N=6, and N=7 sub-wavelength posts, respectively. The s-polarized efficiencies for the three optimized arrays are 94.6%, 95.5% and 93.6%, respectively. The p-polarized efficiencies for the three optimized arrays are 90.6%, 94.1% and 92.6%, respectively. Increasing the number of sub-wavelength structures within the grating's period beyond 8 will result in reduced diffraction efficiencies and increased fabrication complexity due to reduced gaps between the neighboring posts, leading to distorted posts' shapes and difficulties in producing their intended geometries. It is important to pay close attention to the minimum dimensions of and the minimum gaps between the sub-wavelength structures, also referred to as the minimum feature sizes. Sub-wavelength structures with feature sizes that are too small cannot be produced during the fabrication process. Designs with too small gaps between the sub-wavelength structures result in so-called “necking”, when the gap between the neighboring structures is no longer present or is significantly reduced, so that the sub-wavelength structures' shapes become distorted.

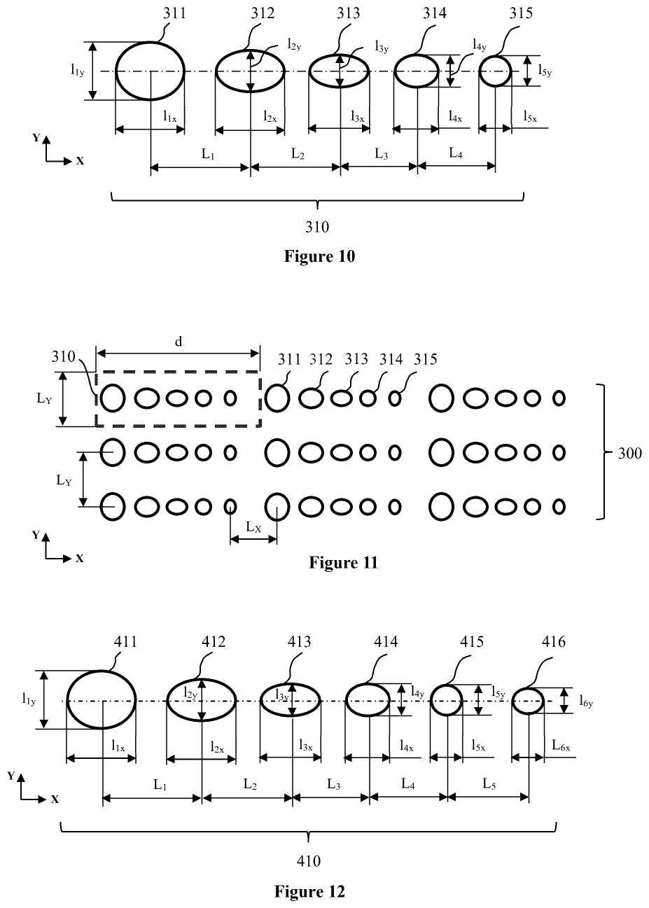

The highest diffraction efficiencies of the array of sub-wavelength structure are achieved when both the lateral dimensions of sub-wavelength structures and their positions within the arrays are adjusted during the array optimization process. FIG. 10 schematically shows the top view of an optimized array 310 corresponding to SWG's period d=3.459 μm that contains 5 cylindrical sub-wavelength posts 311 through 315 with elliptical cross-sections. The sub-wavelength posts 311 through 315 are placed along the X-axis at distances L₁ through L₄. Cross-sections of the posts 311 through 315 have their respective ellipse axes l₁ₓ through l₅ₓ oriented along the X-axis and l_{1y} through l_{5y} oriented along the Y-axis of the coordinate system shown in FIG. 10. Parameter values of the optimized array 310 containing 5 cylindrical posts with elliptically-shaped cross-sections are listed in Table 2. Ellipticities n of the posts are defined by the respective ratios of the ellipse X-axis sizes to the Y-axis sizes, i.e.

$$η = \frac{{l}_{x}}{{l}_{y}} .$$

The average X-axis spacing between the sub-wavelength posts within the array 310 is L_{Xav}=695 nm, or 0.45λ.

TABLE 2

| Post designation | 311 | 312 | 313 | 314 | 315 |
|---|---|---|---|---|---|
| X-axis Size (nm) | 1₁ₓ | 1₂ₓ | 1₃ₓ | 1₄ₓ | 1₅ₓ |
| Value | 398 | 365 | 346 | 313 | 150 |
| Y-axis Size (nm) | 1_{1y} | 1_{2y} | 1_{3y} | 1_{4y} | 1_{5y} |
| Value | 416 | 376 | 347 | 315 | 262 |
| Ellipticity, η | 0.96 | 0.97 | 1.00 | 0.99 | 0.57 |
| X-axis Spacing (nm) | L₁ | L₂ | L₃ | L₄ | L_{X} |
| Value | 698 | 650 | 710 | 722 | 679 |

FIG. 11 schematically shows the top view of a SWG 300 composed of a two-dimensional arrangement of periodically spaced arrays comprised of 5 cylindrical sub-wavelength posts with elliptical cross-sections spaced at non-equal distances. One of the arrays 310 is outlined in FIG. 11 with a dashed line. Arrays 310 are periodically arranged in the X-axis and Y-axis directions, with X-axis periodicity d=3.459 μm, corresponding to the grating's period, and Y-axis periodicity L_{Y}=705 nm or 0.45λ, corresponding to the array width. Distance between the neighboring sub-wavelength posts of the adjacent arrays is L_{X}=679 nm, or 0.44λ.

FIG. 12 schematically shows the top view of a SWG array 410 that contains 6 cylindrical sub-wavelength posts 411 through 416 with elliptical cross-sections and spaced at non-equal distances. The sub-wavelength posts 411 through 416 are placed at distances L₁ through L₅ along the X-axis. Cross-sections of the posts 411 through 416 have their respective ellipse axes lix through lox along the X-axis and l_{1y} through l_{6y} parallel to the Y-axis of the Cartesian coordinate system shown in FIG. 12. Parameter values of the optimized SWG array 410 containing 6 elliptically-shaped sub-wavelength posts are listed in Table 3. The average X-axis spacing between the sub-wavelength posts within the array 410 is L_{Xav}=573 nm, or 0.37λ.

TABLE 3

| Post designation | 411 | 412 | 413 | 414 | 415 | 416 |
|---|---|---|---|---|---|---|
| X-axis Size (nm) | 1₁ₓ | 1₂ₓ | 1₃ₓ | 1₄ₓ | 1₅ₓ | 1₆ₓ |
| Value | 413 | 390 | 363 | 334 | 300 | 125 |
| Y-axis Size (nm) | 1_{1y} | 1_{2y} | 1_{3y} | 1_{4y} | 1_{5y} | 1_{6y} |
| Value | 410 | 362 | 340 | 322 | 288 | 127 |
| Ellipticity, η | 1.01 | 1.08 | 1.07 | 1.04 | 1.04 | 0.98 |
| X-axis Spacing (nm) | L₁ | L₂ | L₃ | L₄ | L₅ | L_{X} |
| Value | 626 | 551 | 541 | 599 | 550 | 592 |

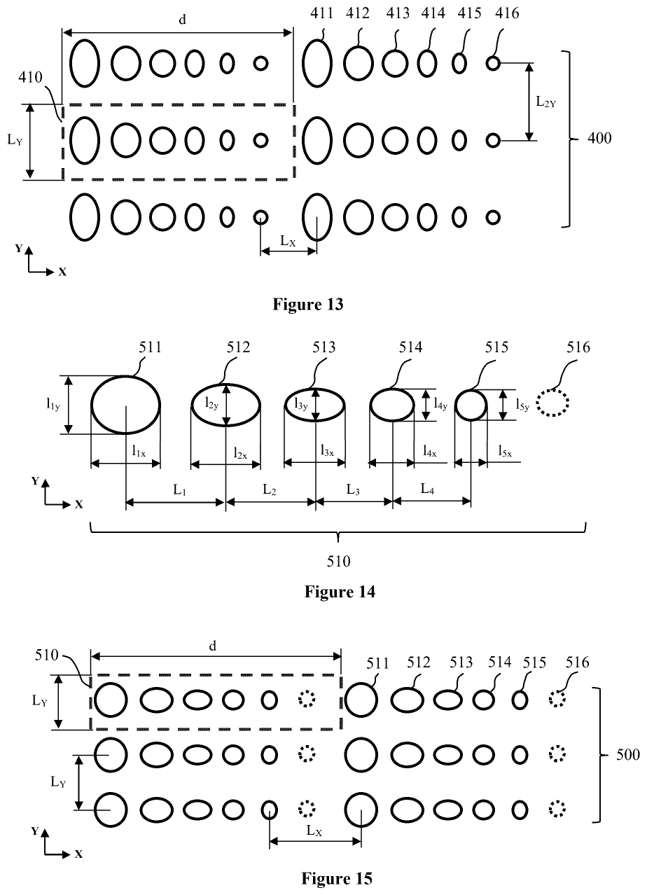

FIG. 13 schematically shows the top view of a SWG 400 composed of a two-dimensional arrangement of periodically spaced arrays comprised of 6 cylindrical sub-wavelength posts with elliptical cross-sections spaced at non-equal distances. One of the arrays 410 is outlined in FIG. 13 with a dashed line. Arrays 410 are periodically arranged in X-axis and Y-axis directions, with X-axis periodicity d=3.459 μm, corresponding to the grating's period, and Y-axis periodicity L_{Y}=755 nm, or 0.49λ, corresponding to the array's width. Distance between the neighboring sub-wavelength posts of the adjacent arrays is L_{X}=592 nm, or 0.38λ.

For the design with N=5, the minimum feature size is 150 nm, and the minimum gap between the sub-wavelength posts is 295 nm. For the design with N=6, the minimum feature size is 125 nm, and the minimum gap between the sub-wavelength posts is 175 nm. The design with N=5 posts is more favorable from a fabrication perspective as compared to the design with N=6 posts, as it has both a larger minimum feature size and minimum gap value. The design with N=6 posts has the highest diffraction efficiency of the three designs. For the design with N=7, the minimum feature size is 136 nm, and the minimum gap between the sub-wavelength posts is 96 nm. The design with N=7 posts is the most challenging to fabricate, and it also does not provide the highest diffraction efficiency.

Selection between the designs with N=5 and N=6 posts will depend on the fabrication capabilities. When the fabrication process is capable of supporting only minimum dimensions at or above 150 nm, then design with N=5 posts should be selected. When the fabrication process is capable of supporting minimum dimensions below 125 nm, then design with N=6 posts will be the preferred choice.

### Embodiment 2

The second embodiment demonstrates design and optimization of SWGs intended to operate with un-polarized light at normal incidence, while also accounting for manufacturability considerations. The SWG is designed for operation at a wavelength of λ=1.55 μm.

When the manufacturing processes cannot support fabrication of the smallest feature sizes of the optimized arrays, an alternative design approach can be applied. In accordance with the second embodiment, sub-wavelength structures with feature sizes below the sizes supported by the manufacturing processes are excluded from the array, therefore producing a topological defect within the arrays. The SWGs composed of the arrays with topological defects are re-optimized by adjusting dimensions and locations of the remaining sub-wavelength structures to achieve the highest diffraction efficiencies of the resulting solutions. Adjustments in locations of sub-wavelength structures within the arrays produced during the re-optimization process are significantly smaller than the distances between the sub-wavelength structures within the arrays. This technique is applicable to any SWG configuration, including those containing cylindrical sub-wavelength posts with circular, elliptical or other cross-sections.

FIG. 14 schematically shows the top view of a SWG array 510 comprised of 5 cylindrical sub-wavelength posts with elliptical cross-sections, spaced at non-equal distances and containing a topological defect. The array 510 has length that corresponds to the SWG's period d=3.459 μm. The array 510 contains 5 cylindrical sub-wavelength posts 511 through 515 with elliptical cross-sections, while the sub-wavelength post 516, shown with dashed lines, was excluded from the array. The sub-wavelength posts 511 through 515 are placed at distances L₁ through L₄ along the X-axis. The posts 511 through 515 have elliptically-shaped cross-sections with the respective ellipse axes lₗₓ through l₅ₓ oriented along the X-axis and l_{1y} through l_{5y} oriented along the Y-axis of the Cartesian coordinate system shown in FIG. 13. Parameter values of the optimized array 510 with topological defect are listed in Table 4. The average X-axis spacing between the sub-wavelength posts within the array 510 is L_{Xav}=577 nm, or 0.372.

TABLE 4

| Post designation | 511 | 512 | 513 | 514 | 515 |
|---|---|---|---|---|---|
| X-axis Size (nm) | 1₁ₓ | 1₂ₓ | 1₃ₓ | 1₄ₓ | 1₅ₓ |
| Value | 425 | 383 | 357 | 326 | 300 |
| Y-axis Size (nm) | 1_{1y} | 1_{2y} | 1_{3y} | 1_{4y} | 1_{5y} |
| Value | 400 | 361 | 336 | 322 | 286 |
| Ellipticity, η | 1.06 | 1.06 | 1.06 | 1.01 | 1.05 |
| X-axis Spacing (nm) | L₁ | L₂ | L₃ | L₄ | L_{X} |
| Value | 635 | 546 | 521 | 604 | 3459 |

FIG. 15 schematically shows the top view of a SWG 500 composed of a two-dimensional arrangement of periodically spaced arrays with topological defects comprised of 5 cylindrical sub-wavelength posts with elliptical cross-sections and spaced at non-equal distances with a topological defect. One of the arrays 510 is outlined in FIG. 15 with a dashed line. Arrays 510 are periodically arranged in the X-axis and Y-axis directions, with X-axis periodicity d=3.459 μm, corresponding to the grating's period, and Y-axis periodicity L_{Y}=757 nm, or 0.49λ, corresponding to the arrays' width. The X-axis distance between the neighboring sub-wavelength posts of adjacent arrays is L_{X}=1153 nm, or 0.74λ. Due to the presence of the topological defect within the array 510, the X-axis distance between the neighboring posts of adjacent arrays is about twice the average distance L_{Xav} between the neighboring posts within the arrays. The absolute diffraction efficiency averaged for the two orthogonal polarization states for the optimized SWG containing a topological defect, as defined in Table 4, is 94.2%. The s-polarized and p-polarized efficiencies for the SWG are 93.0% and 95.4%, respectively. The minimum feature size of the optimized array, as defined in Table 4, was increased to 286 nm, and the minimum gap between the posts was increased to 176 nm.

### Embodiment 3

The third embodiment demonstrates design and optimization of SWGs intended to operate with polarized incident light at normal incidence. The SWGs of the third embodiment also have periodicity of d=3.459 μm and are designed for incident light with linear polarization state. Optimized designs for both s-polarized and p-polarized light are presented. The SWGs are composed of cylindrically-shaped Si sub-wavelength posts fabricated onto a SiO₂ substrate. The thickness of the Si layer that defines the heights of the Si posts is t=0.8 μm. The SWGs are designed for operation at a wavelength of λ=1.55 μm. Similar to the embodiment 1, the no-scattering condition (1) is satisfied for the maximum lattice constant Λ=1.234 μm, and the minimum number of posts contained within the grating's period d, while still satisfying the no-scattering condition (1), will be 3.

Multiple SWG arrays with lengths d=3.459 μm and different numbers of sub-wavelength posts contained within the arrays have been optimized with respect to their diffraction efficiencies for s-polarized and p-polarized light in the 1^{st} diffraction order. The posts' spacings within the arrays and the cross-section shapes of the posts were adjusted to yield the highest diffraction efficiencies of the arrays as ensembles of the posts with controlled coupling between them. The results were compared with diffraction efficiencies of optimized arrays containing equally-spaced cylindrical sub-wavelength posts with circular cross-sections.

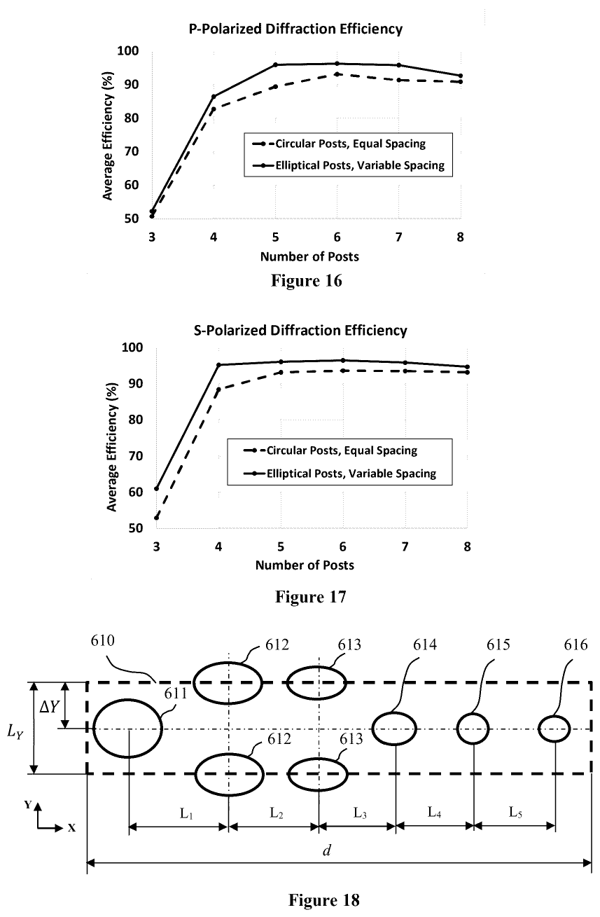

FIGS. 16 and 17 present comparisons between diffraction efficiencies of SWGs optimized for p-polarized light and s-polarized light, respectively. The optimized SWGs in FIGS. 16 and 17 contained different numbers of sub-wavelength posts within the arrays' length d. The number of posts within the arrays was varied from 3 to 8. Increasing the number of posts beyond 7 results in reduced diffraction efficiencies of SWGs. The solid lines in FIGS. 16 and 17 represent diffraction efficiencies of optimized SWGs with non-equal spacing between the neighboring posts with elliptical cross-sections, when both the spacings, sizes and ellipticities of the posts were adjusted to achieve the highest diffraction efficiencies for the respective p-polarized and s-polarized states of incident light. For comparison, the dotted lines in FIGS. 16 and 17 represent the diffraction efficiencies of optimized SWGs containing equally-spaced posts with circular cross-sections, when the cross-section diameters were adjusted to achieve the highest diffraction efficiencies for the respective p-polarized and s-polarized states of incident light. For all SWGs arrangements containing periodic arrays comprised of between 3 and 8 sub-wavelength posts, solutions with posts having elliptical cross-sections and variable spacings outperformed solutions with equally-spaced posts with circular cross-sections.

For p-polarized light, the most efficient SWG designs are achieved for N=5, N=6, and N=7 posts in the array, with absolute diffraction efficiencies in the 1^{st} diffraction order of 95.2%, 95.9% and 95.8%, respectively. For the design with N=5 posts, the minimum feature size is 150 nm, and the minimum gap between the posts is 295 nm. For the design with N=6 posts, the minimum feature size is 127 nm, and the minimum gap between the posts is 164 nm. For the design with N=7 posts, the minimum feature size is 126 nm, and the minimum gap between the posts is 44 nm, making that solution challenging from manufacturing perspective. The design with N=5 posts is more favorable from manufacturing perspective as compared to the design with N=6 posts, as it has the largest minimum feature size and the largest minimum gap between the posts for the three compared designs. Prescription details for the optimized array design with N=5 posts are listed in Table 5. The average X-axis distance between the posts within the array is L_{Xav}=695 nm, or 0.451, and the X-axis distance between the neighboring posts of the adjacent arrays is L_{X}=679 nm, or 0.441. The Y-axis period of the optimized arrays defined in Table 5 is L_{Y}=628 nm, or 0.412.

TABLE 5

| Post designation | 1 | 2 | 3 | 4 | 5 |
|---|---|---|---|---|---|
| X-axis Size (nm) | 398 | 365 | 346 | 313 | 150 |
| Y-axis Size (nm) | 416 | 376 | 347 | 315 | 262 |
| Ellipticity, η | 0.96 | 0.97 | 1.00 | 0.99 | 0.57 |
| X-axis Spacing (nm) | 698 | 650 | 710 | 722 | 679 |

The design with N=6 posts has the highest diffraction efficiency of all the optimized array designs. Prescription details for the optimized array design containing N=6 posts are listed in Table 6. The average X-axis distance between the posts within the array was L_{Xav}=571 nm, and the X-axis distance between the neighboring posts of the adjacent arrays was L_{X}=606 nm, or 0.392. The Y-axis period of the optimized arrays defined in Table 6 was L_{Y}=885 nm, or 0.572.

TABLE 6

| Post designation | 1 | 2 | 3 | 4 | 5 | 6 |
|---|---|---|---|---|---|---|
| X-axis Size (nm) | 421 | 378 | 404 | 334 | 323 | 127 |
| Y-axis Size (nm) | 392 | 398 | 279 | 338 | 249 | 216 |
| Ellipticity, η | 1.07 | 0.95 | 1.45 | 0.99 | 1.30 | 0.59 |
| X-axis Spacing (nm) | 563 | 571 | 555 | 609 | 555 | 606 |

Selection between the designs with N=5 posts and N=6 posts will depend on the manufacturing capabilities. When the manufacturing process is capable of supporting minimum dimensions at or above 150 nm, then design with N=5 posts will be suitable for fabrication. When the fabrication process is capable of supporting minimum dimensions at or below 127 nm, then the design with N=6 posts could be a preferred choice, as it offers the highest absolute diffraction efficiency of all array designs.

For s-polarized light, the most efficient designs are achieved for N=4, N=5, and N=6 sub-wavelength posts within the array, with absolute diffraction efficiencies in the 1^{st} diffraction order of 95.2%, 96.0%, and 96.4%, respectively. The design with N=7 posts had an absolute diffraction efficiency in the 1^{st} diffraction order of 95.8% with the smallest gap between two neighboring posts less than 20 nm, and therefore was excluded from our analysis. For the design with N=4 posts, the minimum feature size was 292 nm, and the minimum gap between the posts was 443 nm. For the design with N=5 posts, the minimum feature size was 105 nm, and the minimum gap between the posts was 256 nm. For the design with N=6 posts, the minimum feature size was 106 nm, and the minimum gap between the posts was 129 nm. Design containing N=4 posts has the largest minimum feature size and the largest minimum gap between the posts within the array, as compared to the designs with N=5 posts and N=6 posts. Prescription details for the array design with N=4 posts are listed in Table 7. The average X-axis distance between the posts within the array was L_{Xav}=843 nm, or 0.54λ, and the X-axis distance between the neighboring posts of the adjacent arrays was L_{X}=929 nm, or 0.60λ. The Y-axis period of the optimized arrays defined in Table 7 was L_{Y}=664 nm, or 0.43λ.

TABLE 7

| Post designation | 1 | 2 | 3 | 4 |
|---|---|---|---|---|
| X-axis Size (nm) | 560 | 357 | 336 | 292 |
| Y-axis Size (nm) | 464 | 414 | 366 | 335 |
| Ellipticity, η | 1.21 | 0.86 | 0.92 | 0.87 |
| X-axis Spacing (nm) | 908 | 789 | 833 | 929 |

When the manufacturing processes are capable of supporting fabrication of gaps between the posts at, or below 129 nm, and the posts with minimum feature sizes at, or below 106 nm, the design with N=6 posts can be chosen, as it provides the highest absolute diffraction efficiency of all of optimized arrays. Prescription details for the optimized array design containing arrays of N=6 posts are listed in Table 8. The average X-axis distance between the posts within the array is L_{Xav}=580 nm, or 0.371, and the X-axis distance between the neighboring posts of the adjacent arrays is L_{X}=561 nm, or 0.36λ. The Y-axis period of the optimized arrays defined in Table 8 was L_{Y}=735 nm, or 0.47λ.

TABLE 8

| Post designation | 1 | 2 | 3 | 4 | 5 | 6 |
|---|---|---|---|---|---|---|
| X-axis Size (nm) | 394 | 388 | 374 | 386 | 274 | 106 |
| Y-axis Size (nm) | 427 | 365 | 332 | 309 | 302 | 155 |
| Ellipticity, η | 0.92 | 1.06 | 1.13 | 1.25 | 0.91 | 0.68 |
| X-axis Spacing (nm) | 660 | 527 | 509 | 629 | 573 | 561 |

### Embodiment 4

The fourth embodiment demonstrates design and optimization of SWGs, while also addressing their manufacturability considerations. SWGs of the fourth embodiment have periodicity of d=3.459 μm, while the minimum feature sizes of the sub-wavelength structures are constrained to specific values supported by the fabrication processes. Constraining the minimum feature sizes of the sub-wavelength structures within arrays represents an alternative approach of improving SWG manufacturability, as compared to the SWGs with topological defects, as described in the second embodiment. The two approaches can also be combined during the SWG design and optimization process. The described topology-constrained meta-surface design and optimization process can be applied not only to arrays consisting of individual discrete sub-wavelength structures, but also to other, more generic array topologies. The more generic array topologies may contain free-form-shaped islands and ridges, and their combinations with sub-wavelength structures shaped as individual posts or etched holes. Optimized SWG array designs for both s-polarized light and p-polarized light with constrained topologies are presented below. The SWG arrays contain Si sub-wavelength structures fabricated onto a SiO₂ substrate. The thickness of the Si layer that defines heights of the Si sub-wavelength structures is t=0.8 μm. The SWGs are designed for operation with linearly polarized light with wavelength of λ=1.55 μm at normal incidence.

While the most advanced lithographic and nano-imprint technologies are capable of producing minimum feature sizes of 100 nm and below, other fabrication processes are limited to larger feature sizes of the sub-wavelength structures. The optimized array designs of the fourth embodiment contain sub-wavelength structures constrained to support manufacturing processes capable of producing the minimum feature sizes at or above 200 nm.

Table 9 presents prescription details of an optimized SWG array containing N=5 sub-wavelength posts for diffracting p-polarized light into the 1^{st} diffraction order. The array has a topological defect, effectively composed of 4 sub-wavelength posts, where one post was excluded from the array, similar to that presented earlier in embodiment 2. The optimized SWG has a diffraction efficiency of 95.2% of light diffracted into the 1^{st} diffraction order, and array periodicity in the Y-axis direction of L_{Y}=795 nm. or 0.51λ. The array design was constrained to have both its minimum feature size and the minimum gap between sub-wavelength posts of 200 nm. The average X-axis distance between the posts within the array is L_{Xav}=648 nm, or 0.422, and the X-axis distance between the neighboring posts of the adjacent arrays is L_{X}=1515 nm, or 0.981. Due to the presence of the topological defect, X-axis distance between the neighboring posts of the adjacent arrays is 2.3 times larger than the average distances between the neighboring posts within the array.

TABLE 9

| Post designation | 1 | 2 | 3 | 4 |
|---|---|---|---|---|
| X-axis Size (nm) | 388 | 345 | 293 | 380 |
| Y-axis Size (nm) | 460 | 457 | 595 | 200 |
| Ellipticity, η | 0.84 | 0.75 | 0.49 | 1.9 |
| X-axis Spacing (nm) | 566 | 656 | 722 | 1515 |

Table 10 presents prescription details of an optimized SWG array containing N=6 sub-wavelength posts for diffracting s-polarized light into the 1^{st} diffraction order. The optimized SWG has a diffraction efficiency of 97.1% of light diffracted into the 1^{st} diffraction order, and array periodicity in the Y-axis direction of L_{Y}=710 nm, or 0.461. The average X-axis distance between the sub-wavelength posts within the array is L_{Xav}=595 nm, or 0.381, and the X-axis distance between the neighboring sub-wavelength posts of the adjacent arrays is L_{X}=484 nm, or 0.312. The design meets manufacturability requirements, as the minimum feature size and the minimum gap between the posts was constrained to be 200 nm.

TABLE 10

| Post designation | 1 | 2 | 3 | 4 | 5 | 6 |
|---|---|---|---|---|---|---|
| X-axis Size (nm) | 346 | 383 | 252 | 266 | 234 | 200 |
| Y-axis Size (nm) | 458 | 368 | 391 | 356 | 317 | 200 |
| Ellipticity, η | 0.76 | 1.04 | 0.64 | 0.75 | 0.74 | 1.00 |
| X-axis Spacing (nm) | 736 | 518 | 459 | 711 | 551 | 484 |

### Embodiment 5

The fifth embodiment demonstrates three alternative designs of optimized SWGs arrays containing sub-wavelength structures, where at least one of the sub-wavelength structures within the arrays is laterally offset from the rest of the sub-wavelength structures. The arrays are comprised of cylindrical sub-wavelength posts with elliptical cross-sections and variable spacings. The arrays' lengths along the X-axis are d, and the arrays' widths along the Y-axis are L_{Y}. The lateral offsets of sub-wavelength structures are made along the Y-axis direction and are intended for improving manufacturability of SWGs by increasing the gaps between the neighboring sub-wavelength structures within the arrays. The increase in gaps between the sub-wavelength structures is especially important in arrays containing larger numbers of sub-wavelength structures.

The lateral offsets of sub-wavelength structures can be combined with other techniques that improve manufacturability of SWGs, including the exclusion from the arrays sub-wavelength structures with feature sizes below the values supported by the manufacturing processes, and constraining the minimum feature sizes and gaps between the structures to the values supported by the manufacturing processes, as described in embodiments 2 and 4. The number of laterally offset sub-wavelength structures within the arrays can range from a single structure to several structures. The lateral offsets can be made in any combination of consecutive and non-consecutive structures within the arrays. The largest lateral offset value ΔYᵢ of a sub-wavelength structure within an array corresponds to half the lateral width L_{Y} of the array, i.e.

$$Δ {Y}_{i max} = {L}_{Y} / 2 \qquad ( 3 )$$

The exemplary array designs of the fifth embodiment are shown in FIGS. 18 through 22, and are designed to operate with p-polarized incident light at normal incidence and the operating wavelength of 2=1.55 μm. Arrays have X-axis length of d=3.459 μm that define the SWG X-axis periodicity, and Y-axis width L_{Y} that defines the arrays' periodicity in the Y-axis direction.

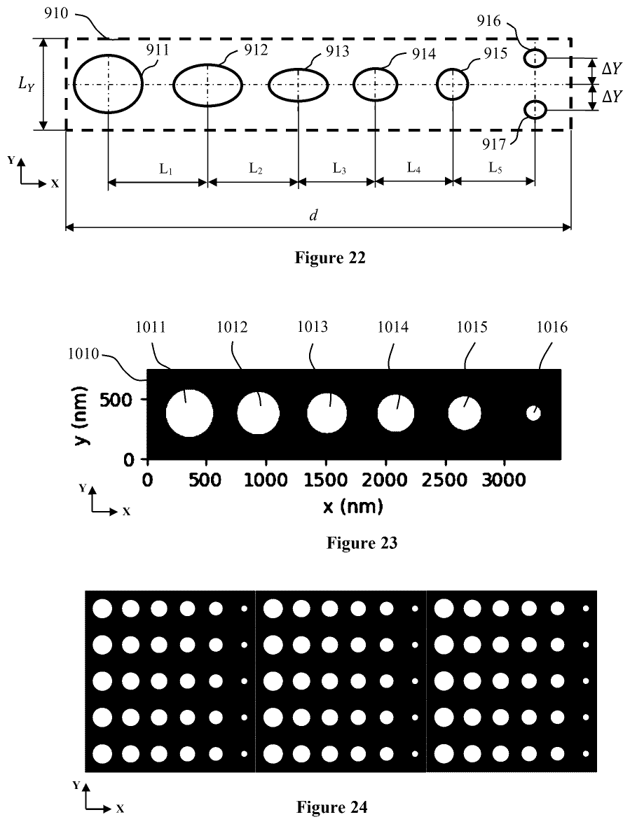

Sub-wavelength structures of the designs shown in FIGS. 18 through 21 are laterally offset from the rest of the sub-wavelength structures by ΔYᵢ_{ₘₐₓ}=L_{Y/2}, or half the widths of the arrays, so that the laterally offset structures are being equally shared by the neighboring arrays, laterally spaced in Y-axis direction. Smaller offset values ΔY can also be used during the design process, and are shown in the exemplary embodiment in FIG. 22.

FIG. 18 schematically shows the top view of the first SWG array design 610 with laterally offset sub-wavelength structures. Array 610 comprises 8 cylindrical sub-wavelength posts 611 through 618 with elliptical cross-sections and variable spacings between the posts. The two neighboring post 612 and 613 are offset from the array centerline in the positive Y-axis direction by ΔY=L_{Y}/2, and the two neighboring posts 617 and 618 are offset from the array centerline in the negative Y-axis direction by −ΔY=−L_{Y}/2. The laterally offset post 612 is identical to the laterally offset post 617, and the laterally offset post 613 is identical to the laterally offset post 618. The posts 611 through 618 are placed at distances L₁ through L₅ along the X-axis. The posts 611 through 618 have their respective ellipse axes l₁ₓ through l₆ₓ oriented along the X-axis and ellipse axes l_{1y} through l_{6y} oriented along the Y-axis of the Cartesian coordinate system shown in the figure. Parameter values of the optimized array 610 with laterally offset posts 612, 613, 617 and 618 are listed in Table 11. The average X-axis distance between the posts within the array 610 is L_{Xav}=577 nm, or 0.37λ.

TABLE 11

| Post designation | 611 | 612, 617 | 613, 618 | 614 | 615 | 616 |
|---|---|---|---|---|---|---|
| X-axis Size (nm) | 1₁ₓ | 1₂ₓ | 1₃ₓ | 1₄ₓ | 1₅ₓ | 1₆ₓ |
| Value | 395 | 398 | 409 | 331 | 391 | 200 |
| Y-axis Size (nm) | 1_{1y} | 1_{2y} | 1_{3y} | 1_{4y} | 1_{5y} | 1_{6y} |
| Value | 456 | 408 | 298 | 382 | 200 | 353 |
| Ellipticity, η | 0.87 | 0.98 | 1.37 | 0.87 | 1.96 | 0.57 |
| X-axis Spacing (nm) | L₁ | L₂ | L₃ | L₄ | L₅ | L_{X} |
| Value | 440 | 604 | 496 | 678 | 744 | 497 |

Arrays 610 are periodically arranged in the X-axis and Y-axis directions, with X-axis periodicity d=3.459 μm corresponding to the grating's period, and Y-axis periodicity L_{Y}=806 nm, or 0.521, corresponding to the array size in Y-axis direction. The X-axis distance between the neighboring sub-wavelength posts of the adjacent arrays is L_{X}=497 nm, or 0.321. Absolute diffraction efficiency of the SWG arrays 610 is 95.5% for p-polarized incident light at normal incidence. The minimum feature size of the optimized design in Table 11 is constrained to 200 nm, and the minimum gap between the posts was also constrained to 200 nm.

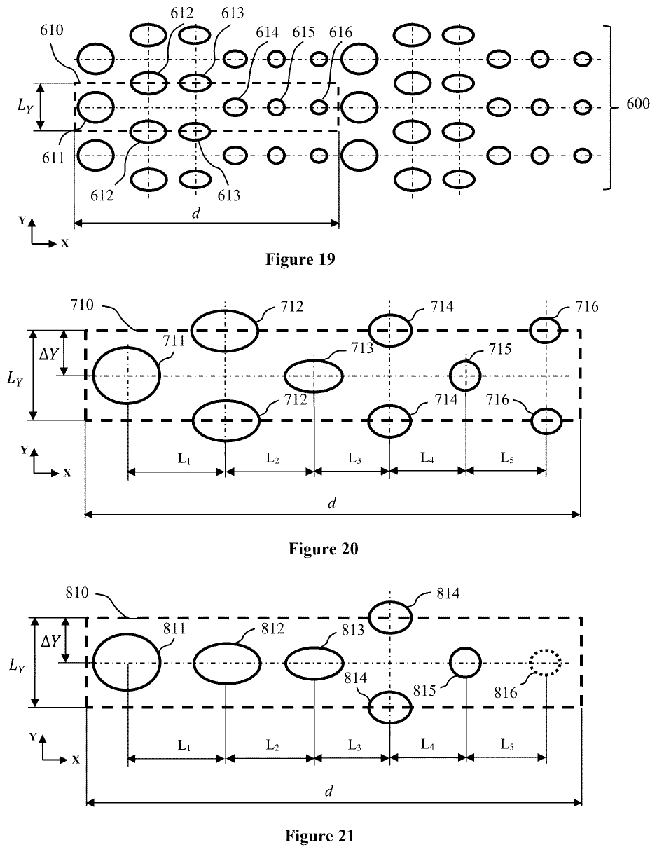

FIG. 19 schematically shows the top view of a SWG 600 composed of a two-dimensional arrangement of periodically spaced arrays 610. Arrays 610 are periodically arranged at distances d=3.459 μm along the X-axis direction, and at distances L_{Y}=806 nm along the Y-axis direction. Top view of the SWG arrays 610 was shown in FIG. 18, and their prescription details are listed in Table 11. The posts 612 and 613 are laterally offset in Y-axis direction by half the array width L_{Y}/2=403 nm and are shared between the array 610, outlined by a dashed line in FIG. 19, and the identical neighboring array placed in positive Y-axis direction. The posts 617 and 618 are laterally offset in the Y-axis direction by half the array width −L_{Y}/2=−403 nm and are shared between the array 610, outlined by a dashed line in FIG. 19, and the identical neighboring array placed in the negative Y-axis direction

FIG. 20 schematically shows the top view of the second SWG array design 710 with laterally offset sub-wavelength structures. Array 710 is comprised of 9 cylindrical sub-wavelength posts 711 through 719 with elliptical cross-sections and variable spacings between the posts. The posts 712, 714 and 716 are offset from the array centerline in the positive Y-axis direction by ΔY=L_{Y}/2, and the posts 717, 718 and 719 are offset from the array centerline in the negative Y-axis direction by −ΔY=−L_{Y}/2. The laterally offset post 712 is identical to the laterally offset post 717, the laterally offset post 714 is identical to the laterally offset post 718, and the laterally offset post 716 is identical to the laterally offset post 719. The posts 711 through 719 are placed at distances L₁ through L₅ along the X-axis. The posts 711 through 719 have their respective ellipse axes l₁ₓ through lox oriented along the X-axis and ellipse axes l_{1y} through l_{6y} oriented along the Y-axis of the Cartesian coordinate system shown in the figure. The posts 712, 714 and 716 will be shared with the neighboring array in the positive Y-axis direction, and the posts 717, 718 and 719 will be shared with the neighboring array in the negative Y-axis direction. Parameter values of the optimized SWG array 710 with laterally offset posts 712, 714, 716, 717, 718, and 719, are listed in Table 12. The average X-axis distance between the posts within the array 710 is L_{Xav}=577 nm, or 0.37λ.

TABLE 12

| Post designation | 711 | 712, 717 | 713 | 714, 718 | 715 | 716, 719 |
|---|---|---|---|---|---|---|
| X-axis Size (nm) | 1₁ₓ | 1₂ₓ | 1₃ₓ | 1₄ₓ | 1₅ₓ | 1₆ₓ |
| Value | 399 | 402 | 387 | 331 | 319 | 200 |
| Y-axis Size (nm) | 1_{1y} | 1_{2y} | 1_{3y} | 1_{4y} | 1_{5y} | 1_{6y} |
| Value | 470 | 391 | 331 | 379 | 321 | 351 |
| Ellipticity, η | 0.85 | 1.03 | 1.17 | 0.87 | 1.02 | 0.57 |
| X-axis Spacing (nm) | L₁ | L₂ | L₃ | L₄ | L₅ | L_{X} |
| Value | 456 | 589 | 549 | 632 | 734 | 499 |

Arrays 710 are periodically arranged in the X-axis and Y-axis directions, with X-axis periodicity d=3.459 μm corresponding to the grating's period, and Y-axis periodicity L_{Y}=782 nm, or 0.50λ, corresponding to the array size in the Y-axis direction. The X-axis distance between the neighboring posts of adjacent arrays is L_{X}=499 nm, or 0.321. The absolute diffraction efficiency of the SWG arrays 710 is 96.4% for p-polarized incident light at normal incidence. The minimum feature size of the design in Table 12 was constrained to 200 nm, and the minimum gap between the posts was also constrained to 200 nm.

FIG. 21 schematically shows the top view of the third SWG array design 810 with laterally offset sub-wavelength structures. Array 810 comprises 6 cylindrical sub-wavelength posts 811 through 816 with elliptical cross-sections, variable spacings between the posts, and a topological defect. The post 817 had dimensions that do not satisfy manufacturability requirements, and was excluded from the array 810 to produce the topological defect. The post 814 is offset from the array centerline by ΔY=L_{Y}/2 in the positive Y-axis direction, and the post 816 is offset from the array centerline in the negative Y-axis direction by −ΔY=−L_{Y}/2. The laterally offset post 814 is identical to the laterally offset post 816. The posts 811 through 816 are placed at distances L₁ through L₅ along the X-axis. The posts 811 through 816 have their respective ellipse axes lₗₓ through lox oriented along the X-axis and ellipse axes l_{1y} through l_{6y} oriented along the Y-axis of the Cartesian coordinate system shown in the figure. The post 814 will be shared with the neighboring array in the positive Y-axis direction, and the post 816 will be shared with the neighboring array in the negative Y-axis direction. Parameter values of the optimized SWG array 810 with laterally offset posts 814 and 816 are listed in Table 13. The average X-axis distance between the posts within the array 810 is L_{Xav}=537 nm, or 0.35λ.

TABLE 13

| Post designation | 811 | 812 | 813 | 814, 816 | 815 |
|---|---|---|---|---|---|
| X-axis Size (nm) | 1₁ₓ | 1₂ₓ | 1₃ₓ | 1₄ₓ | 1₅ₓ |
| Value | 401 | 383 | 309 | 411 | 285 |
| Y-axis Size (nm) | 1_{1y} | 1_{2y} | 1_{3y} | 1_{4y} | 1_{5y} |
| Value | 433 | 393 | 542 | 200 | 342 |
| Ellipticity, η | 0.93 | 0.95 | 0.57 | 2.06 | 0.83 |
| X-axis Spacing (nm) | L₁ | L₂ | L₃ | L₄ | L₅ |
| Value | 549 | 574 | 560 | 465 | 1860 |

Arrays 810 are periodically arranged in the X-axis and Y-axis directions, with X-axis periodicity d=3.459 μm corresponding to the grating's period, and Y-axis periodicity L_{Y}=881 nm, or 0.57λ corresponding to the arrays' width. The X-axis distance between neighboring posts of the adjacent arrays is L_{X}=1860 nm, or 1.20λ. Due to exclusion of the post 817 from the array 810, the X-axis distance between the neighboring posts of the adjacent arrays is about 3.5 times the average distance L_{Xav} between the neighboring posts within the arrays. Absolute diffraction efficiency of the optimized SWG arrays 810 was of 96.8% for p-polarized light at normal incidence. The minimum feature size of the optimized array design shown in Table 13 was 200 nm, and the minimum gap between the posts was 162 nm.

FIG. 22 schematically shows the top view of the SWG array design 910 with laterally offset sub-wavelength structures. Array 910 is comprised of 7 cylindrical sub-wavelength posts 911 through 917 with elliptical cross-sections and variable spacings between the posts. The post 916 is offset from the array centerline in the positive Y-axis direction by ΔY, and the post 917 is offset from the array centerline in the negative Y-axis direction by ΔY. The laterally offset post 916 is identical to the laterally offset post 917. The posts 911 through 919 are placed at distances L₁ through L₅ along the X-axis. The posts 911 through 917 have their respective ellipse axes lix through lox oriented along the X-axis and ellipse axes l_{1y} through l_{6y} oriented along the Y-axis of the Cartesian coordinate system shown in the figure. The offset values ΔY are not large enough to place the offset posts outside of the array 910 boundary, so the offset posts 916 and 917 will not be shared with the neighboring arrays. Parameter values of the optimized SWG array 910 with laterally offset posts 916 and 917 are listed in Table 14. The average X-axis distance between the posts within the array 910 is L_{Xav}=577 nm, or 0.372.

TABLE 14

| Post designation | 911 | 912 | 913 | 914 | 915 | 916, 917 |
|---|---|---|---|---|---|---|
| X-axis Size (nm) | 1₁ₓ | 1₂ₓ | 1₃ₓ | 1₄ₓ | 1₅ₓ | 1₆ₓ |
| Value | 419 | 386 | 366 | 352 | 314 | 150 |
| Y-axis Size (nm) | 1_{1y} | 1_{2y} | 1_{3y} | 1_{4y} | 1_{5y} | 1_{6y} |
| Value | 393 | 382 | 346 | 294 | 264 | 150 |
| Ellipticity, η | 1.07 | 1.01 | 1.06 | 1.20 | 1.19 | 1.00 |
| X-axis Spacing (nm) | L₁ | L₂ | L₃ | L₄ | L₅ | L_{X} |
| Value | 577 | 576 | 577 | 576 | 577 | 576 |

Arrays 910 are periodically arranged in the X-axis and Y-axis directions, with X-axis periodicity d=3.459 μm corresponding to the grating's period, and Y-axis periodicity L_{Y}=895 nm, or 0.581, corresponding to the array size in the Y-axis direction. The X-axis distance between the neighboring posts of adjacent arrays is L_{X}=576 nm, or 0.372. The absolute diffraction efficiency of the SWG array 910 is 95.3% for p-polarized incident light at normal incidence. The minimum feature size of the design in Table 14 was constrained to 150 nm, and the minimum gap between the posts was 328 nm.

### Embodiment 6

It is desirable to find alternative SWG designs that can even further increase diffraction efficiencies in the working diffraction orders. An additional increase in the SWG diffraction efficiencies can be achieved when the cross-sections of the subwavelength posts within the arrays can be designed and optimized by adding additional degrees of freedom during the optimization process. Analytically defined structures, such as circularly-shaped or elliptically-shaped structures, can be parametrized, so that their radii and centroids could be varied during the optimization process with the goal of achieving the highest diffraction efficiency. The new design and optimization approach used to design the SWGs of embodiment 6 is based on using sub-wavelength structures with complex cross-sections based on polygonal shapes that are composed of linear or curvilinear segments. While the individual segments may have analytical definition, the entire cross-section cannot be defined analytically as a single polynomial. The shapes may have concave and convex regions. The shapes of the cross-sections are varied during the optimization process with the goal of achieving the highest diffraction efficiencies in the working orders. The cross-sections composed of individual segments will be referred to in the following description as freeform-shaped cross-sections. A combination of free-form and analytically defined pillar cross-sections can also be used in SWG designs. The use of subwavelength structures with freeform-shaped cross-sections allows for increased diffraction efficiencies of SWG designs compared to the efficiencies of the starting point designs achieved using parameterized definitions of cross-sections of the subwavelength structures.

The sixth embodiment demonstrates five exemplary designs of optimized SWGs arrays containing sub-wavelength structures, where the arrays are composed of Si sub-wavelength posts with freeform-shaped lateral cross-sections and are fabricated on SiO₂ supporting substrate. The thickness of the Si layer that defines the height of the Si posts is t=0.8 μm. The SWGs are designed for operation at normal incidence and a wavelength of λ=1.55 μm. Alternative grating designs can be made for off-normal angles of incidence and difference operating wavelengths.

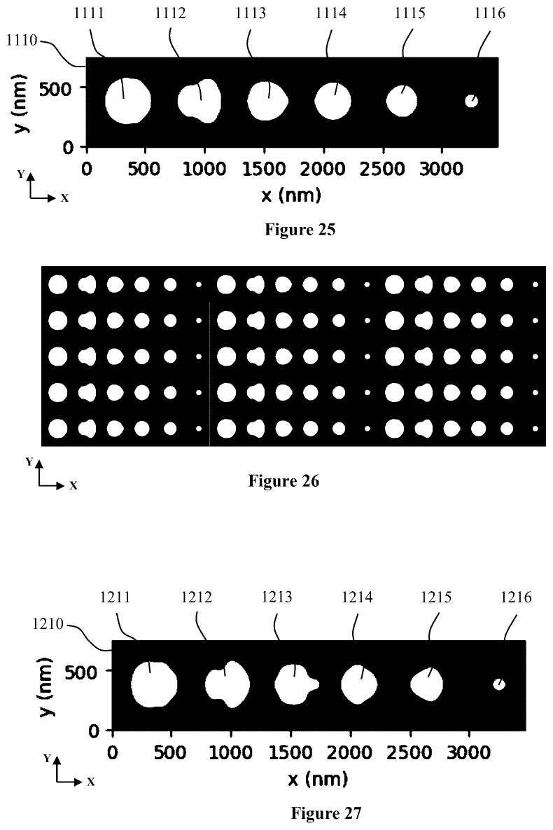

The first four exemplary designs, presented by FIGS. 25 through 32, are based on the starting point structure that has 6 equally-spaced subwavelength posts with circular cross-sections and presented on FIGS. 23 and 24. A great variety of alternative optimized designs of the SWGs containing sub-wavelength structures with freeform-shaped lateral cross-sections can be produced based on the same optimization starting point by imposing different constraints during the optimization process. The four exemplary SWG designs and the optimization starting point have arrays' lengths along the X-axis d=3459 nm, and the arrays' widths along the Y-axis L_{Y}=753 nm. The four designs use the same starting point SWG unit cell design composed of a linear array of equally-spaced posts with circular cross-sections shown in FIGS. 23 and 24.

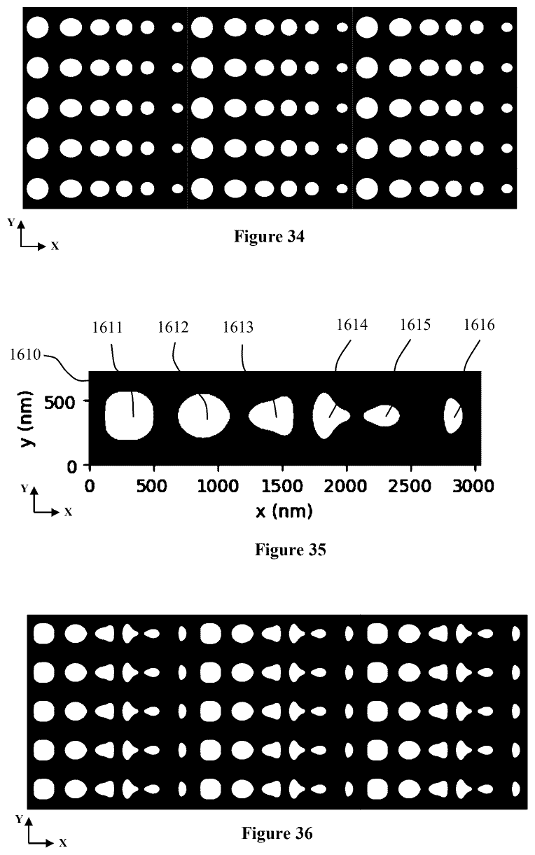

The fifth exemplary design, shown in FIGS. 35 and 36, is based on the starting point structure that has 6 unequally-spaced subwavelength posts with elliptical cross-sections, and shown in FIGS. 33 and 34. The fifth exemplary SWG designs and the respective optimization starting point have arrays' lengths along the X-axis d=3039 nm, and the arrays' widths along the Y-axis L_{Y}=754 nm.

FIG. 23 shows the top view of a baseline SWG unit cell 1010 composed of a linear array of 6 equally-spaced cylindrical subwavelength posts 1011 through 1016 having circular cross-sections defined by the white regions of the unit cell. The length of the unit cell along the X-axis is d=3459 nm, and along the Y-axis is L_{Y}=753 nm. Prescription details of the optimized array 1010 was listed earlier in Table 1. The optimized SWG composed of arrays of sub-wavelength structures 1010 yields an average diffraction efficiency in the 1^{st} diffraction order of 91.6%, with the s-polarized and p-polarized efficiencies for the structure are 90.7% and 92.6%, respectively. FIG. 24 shows a top view of the SWG array containing a two-dimensional array of the unit cells 1010 in FIG. 23. While a small 3×5 array of the cells 1010 is shown in FIG. 24 for illustration purposes, the actual SWGs may contain millions or even billions of the unit cells.

FIG. 25 shows the top view of a first optimized SWG unit cell design 1110 containing 6 sub-wavelength posts 1111 through 1116 with freeform-shaped cross-sections. The baseline SWG unit cell design 1010 in FIG. 23 was used as a starting point during the optimization process, and resulted in the subwavelength posts with freeform-shaped cross-sections shown in FIG. 25. The amount of shape change was constrained during the optimization process. The resulting optimized unit cell 1110 has 6 subwavelength posts with freeform-shaped cross-sections that morphed from the starting circular shaped cross-section. A top view of an optimized SWG composed of arrays of the unit cells 1110 is shown in FIG. 26. The starting point SWG of the first example was optimized using parameterized polynomial definition of the cross-sections of posts 1111 through 1116, and yields an average diffraction efficiency in the 1st diffraction order of 94.1%, with the s-polarized and p-polarized efficiencies for the structure equal to 93.1% and 95.2%, respectively. A small 3×5 array of the unit cells 1110 is shown in FIG. 26 for illustrative purposes. The data exchange of the freeform-shaped SWGs between the design and fabrication processes is performed using Electronic Design Automation (EDA) file formats, such as Geometric Database Standard for Information Exchange (GDSII) or the Open Artwork System Interchange Standard (OASIS).

Different starting point designs can be used during the optimization process, including designs based on subwavelength structures with circular, elliptical and freeform-shaped cross-sections. Starting points with random spatial distribution can also be used during the optimization process. We found that the final optimized shape of the SWG strongly depends on the optimization starting point designs and the amount of the shape change constraints imposed onto the SWG topologies during the optimization process.

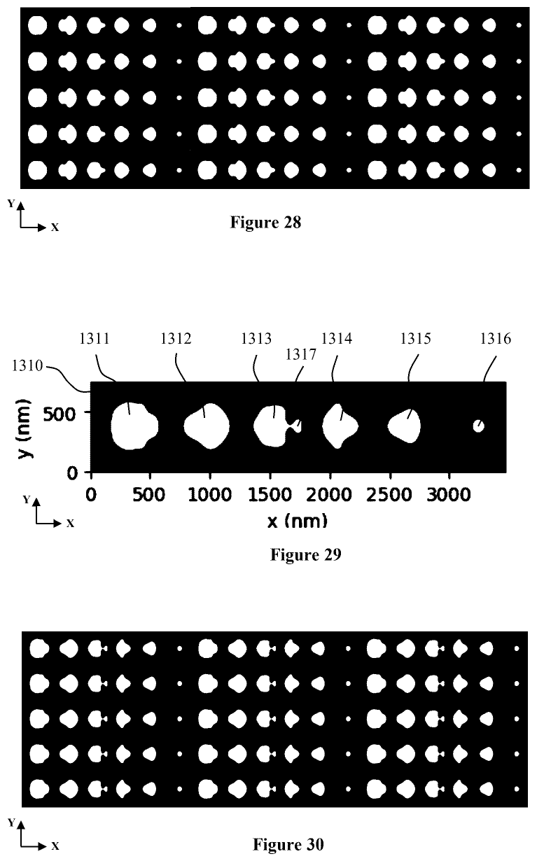

FIG. 27 shows the top view of a second optimized SWG unit cell design 1210 containing 6 sub-wavelength posts 1211 through 1216 with freeform-shaped cross-sections. The freeform-shaped cross-sections are produced as a result of the optimization process, when the baseline linear array shown in FIG. 23 was used as the optimization starting point. During the optimization process, the amount of change to the posts' cross-sections was constrained to a lesser extent, as compared to the first design in FIG. 25. While the resulting freeform-shaped cross-sections that morphed from the starting circular shaped cross-section have larger deviations from the starting point circular shapes, the number of the subwavelength posts within the SWG unit cell was maintained at 6. A top view of the optimized SWG composed of arrays of the unit cells 1210 is shown in FIG. 28, and yields an average diffraction efficiency in the 1^{st} diffraction order of 94.4%, with the s-polarized and p-polarized efficiencies for the structure equal to 93.2% and 95.6%, respectively. The small 3×5 array of the unit cells 1210 in FIG. 28 is shown for illustration purposes. The data exchange of the freeform-shaped SWGs between the design and fabrication processes is performed using GDSII or OASIS file formats.

FIG. 29 shows the top view of a third optimized SWG unit cell design 1310 that containing 6 sub-wavelength posts 1311 through 1316 with freeform-shaped cross-sections. The cross-section shapes have emerged from the starting point optimization of 6 cylindrical sub-wavelength posts with circular cross-sections. The constraints on the posts' cross-sections were further reduced as compared to the second design in FIG. 27, and resulted in significant deviations of the optimized freeform-shaped cross-sections of the subwavelength structures from the circular-shaped starting point. A top view of the optimized SWG composed of arrays of the unit cells 1310 is shown in FIG. 30, and yields an average diffraction efficiency in the 1st diffraction order of 94.5%, with the s-polarized and p-polarized efficiencies for the structure are 93.2% and 95.7%, respectively. Cross-section of the sub-wavelength post 1313 has a small region 1317 facing the sub-wavelength post 1314. Due to the small size of that region it will be difficult to reproduce its shape during the fabrication process. The SWG design shown in FIGS. 29 and 30 is more sensitive to shape distortions during the fabrication process as compared to the design in FIGS. 26 and 27. Distortions of the shape will result in reduced diffraction efficiencies of the fabricated SWGs. The data exchange of the freeform-shaped SWGs between the design and fabrication processes is performed using GDSII or OASIS file formats. The schematic 3×5 array of the unit cells 1310 composing the SWG in FIG. 30 is shown for illustration purposes. The actual SWG designs defined by the GDSII or OASIS layout files may contain millions or even billions of the optimized unit cells.

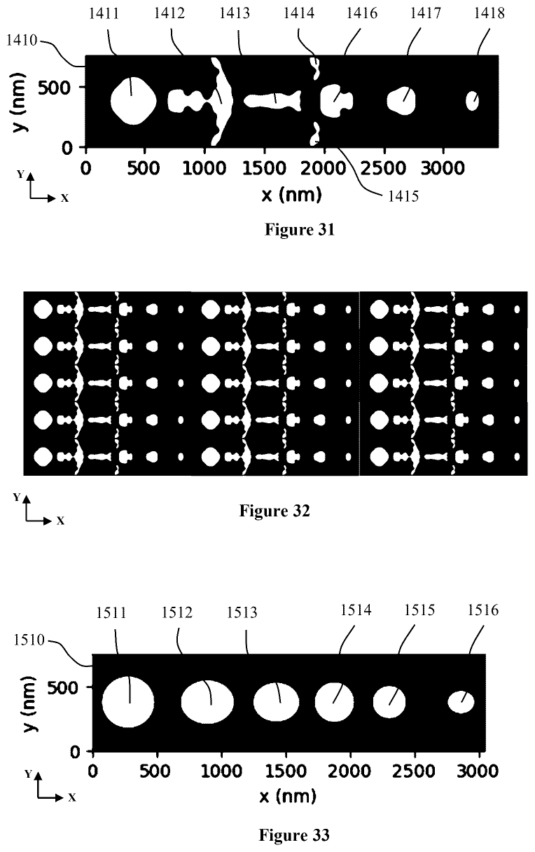

FIG. 31 shows the top view of a fourth optimized SWG unit cell design 1410 that has emerged from the optimization starting point based on 6 cylindrical sub-wavelength posts with circular cross-sections. A constraint on the freeform shapes has not been imposed as compared to the previous designs shown in FIGS. 25, 27, and 29. The resulting unit cell with freeform-shaped structures no longer resembles the starting point unit cell design with circular-shaped cross-sections. The number of subwavelength posts 1311 through 1318 contained in the optimized unit cell increased from 6 to 8. A top view of the optimized SWG composed of arrays of the unit cells 1410 is shown in FIG. 32, and yields an average diffraction efficiency in the 1^{st} diffraction order of 94.6%, with the s-polarized and p-polarized efficiencies for the structure are 93.5% and 95.7%, respectively. Cross-section of the sub-wavelength posts 1412, 1414 and 1415 contain small region that will be difficult to reproduce its shape during the fabrication process. The SWG design shown in FIGS. 31 and 32 is more sensitive to shape distortions during the fabrication process as compared to the design in FIGS. 29 and 30. The shape distortions of sub-wavelength posts 1412, 1414 and 1415 will result in reduced diffraction efficiencies of the fabricated SWGs. The data exchange of the freeform-shaped SWGs between the design and fabrication processes is performed using GDSII or OASIS file formats. The schematic 3×5 array of the unit cells 1310 composing the SWG in FIG. 30 is shown for illustration purposes. The actual SWG designs defined by the GDSII or OASIS layout files may contain millions or even billions of the optimized unit cells.

Sensitivity of the four optimized SWG designs to manufacturing imperfections increases from the first design in FIG. 25 to the fourth design in FIG. 31. The fourth design 1410 shown in FIG. 31 is highly sensitive to manufacturing imperfections and may not be considered the best choice. The first design 1110 in FIG. 25, albeit slightly lower diffraction efficiency as compared to the other designs, has the lowest sensitivity to manufacturing imperfections. Selection of the optimum design depends on the ability of the fabrication process in reproducing the freeform shapes of the subwavelength structures.

FIG. 33 shows the top view of a baseline SWG unit cell 1510 composed of an array of 6 unequally-spaced cylindrical subwavelength posts 1511 through 1516 having elliptical cross-sections. The length of the unit cell along the X-axis is d=3039 nm, and along the Y-axis is L_{Y}=754 nm. The starting point SWG composed of the unit cells 1510 was optimized using parameterized polynomial cross-sections definition of the posts 1511 through 1516, and yields an average diffraction efficiency in the 1^{st} diffraction order of 92.2%, with s-polarized and p-polarized efficiencies for the structure equal to 89.3% and 95.0%, respectively. FIG. 34 shows a top view of the SWG containing a two-dimensional array of the unit cells 1510. The data exchange between the design and fabrication processes for the SWG in FIG. 34 is performed using GDSII or OASIS file formats. While a small 3×5 array of the cells 1510 is shown in FIG. 34 for illustration purposes, the actual SWGs may contain millions or even billions of the unit cells.

FIG. 35 shows the top view of an optimized SWG unit cell 1610 in accordance with the fifth exemplary design. The optimized layout of the unit cell 1610 resulted from an optimization process using as the starting point the unit cell 1510 with 6 cylindrical sub-wavelength posts having elliptical cross-sections and shown in FIG. 33. The resulting unit cell 1610 is composed of 6 subwavelength posts 1611 through 1616 with freeform-shaped cross-sections. A top view of the optimized SWG composed of arrays of the unit cells 1610 is shown in FIG. 36. The SWG of the fifth exemplary design yields an average diffraction efficiency in the 1st diffraction order of 97.3%, with the s-polarized and p-polarized efficiencies for the structure are 97.8% and 96.9%, respectively. The data exchange of the freeform-shaped SWGs between the design and fabrication processes should be performed using GDSII or OASIS file formats.

To assure accurate reproduction of the subwavelength posts with freeform-shaped cross-sections during the fabrication process, shapes of the freeform cross-sections can be modified to compensate for the anticipated shapes' changes associated with the fabrication process. Precorrection techniques are commonly used during the fabrication of semiconductor integrated circuits and silicon photonics devices using high resolution projection lithography, and could be applied to yield more accurate freeform-shaped cross-sections of the SWG posts.

### REFERENCES

1. U.S. Pat. No. 9,103,973 “Sub-Wavelength Grating-Based Optical Elements”, issued Aug. 11, 2015.
2. U.S. Pat. No. 10,459,258 “Meta Optical Device and Method of Designing the Same”, issued Oct. 29, 2019.
3. Y. Soskind, “Field Guide to Diffractive Optics”, SPIE Press, 2011, page 73.
4. E. Arbabi, et al. “Multiwavelength polarization-insensitive lenses based on dielectric metasurfaces with array of sub-wavelength structures.” Optica, Vol. 3, No. 6, 2016, pp. 628-633. https://opg.optica.org/optica/fulltext.cfm?uri=optica-3-6-628&id=344427
5. Z. Liu, et al. “Compounding meta-atoms into metamolecules with hybrid artificial intelligence techniques.” Advanced Materials, V. 32, No. 6, 2020, p. 1904790. https://onlinelibrary.wiley.com/doi/am-pdf/10.1002/adma.201904790
6. Z. Ren, et al. “Investigation of the corner rounding effect near the diffraction limit in advanced projection lithography with a rigorous imaging model.” Optics Express 33.1 (2025): 1517-1532. https://opg.optica.org/oe/fulltext.cfm?uri=oe-33-1-1517&id=566881
7. X. Ma, et al. “Model-driven convolution neural network for inverse lithography.” Optics express 26.25 (2018): 32565 32584. https://opg.optica.org/oe/fulltext.cfm?uri=oe-26-25-32565&id=402663

1. A method for computer-aided design of diffraction gratings that include sub-wavelength structures, comprising:
(a) analyzing design requirements of a diffraction grating for diffracting light having an operating wavelength;
(b) selecting a material composition of a grating substrate and of the sub-wavelength structures;
(c) selecting a layer thickness defining a height of the sub-wavelength structures;
(d) defining a plurality of sub-wavelength structures that are arranged into an array layout, the array layout having a length and a width, said array length corresponding to a grating periodicity along one direction and said array width corresponding to an array periodicity in an orthogonal direction;
(e) optimizing the array layout in order to satisfy said design requirements by optimizing shapes, heights and/or locations of at least some of the sub-wavelength structures, said sub-wavelength structures having freeform-shaped cross-sections, and by optimizing said array width;
(f) analyzing a diffraction grating design with respect to the design requirements, the diffraction grating design including a plurality of the optimized arrays;
(g) determining if the diffraction grating design satisfies the design requirements.

2. The method of claim 1, further comprising imposing constraints onto an allowable extent of shape changes to the freeform-shaped cross-sections of the sub-wavelength structures during optimization.

3. The method of claim 1, further comprising suppressing formation of smaller-sized regions during optimization.

4. The method of claim 1, wherein the design requirements include a required output energy distribution and manufacturability of the diffraction grating design.

5. A method of computer-aided design in accordance with claim 1, wherein the optimized array layout output from step (e) is used as a starting point for subsequent optimization cycles.

6. A method for computer-aided design of diffraction gratings that include sub-wavelength structures, comprising:
(a) analyzing design requirements of a grating for diffracting light having an operating wavelength;
(b) selecting a material composition of a grating substrate and of the sub-wavelength structures;
(c) selecting a layer thickness defining a height of the sub-wavelength structures;
(d) selecting a starting array layout that includes a plurality of sub-wavelength structures, said array layout having a length and a width, said array layout length corresponding to a grating periodicity along one direction and said array layout width corresponding to an array periodicity in an orthogonal direction;
(e) optimizing the array layout in order to satisfy said design requirements by optimizing shapes, heights and/or locations of at least some of the sub-wavelength structures within the array layout, said sub-wavelength structures having freeform-shaped cross-sections, and by optimizing said array width;
(f) analyzing a diffraction grating design with respect to the design requirements, the diffraction grating design including a plurality of the optimized arrays;
(g) determining if the diffraction grating design satisfies the design requirements and manufacturability requirements.
(h) modifying said optimized array layout to satisfy the design requirements and the manufacturability requirements;
(i) repeating steps (e) through (h) to obtain a plurality of diffraction grating designs, and
(j) selecting the diffraction grating design from among the plurality of diffraction grating designs which most closely satisfies the design requirements and the manufacturability requirements.

7. The method of claim 6, further comprising imposing constraints onto an allowable extent of shape changes to the freeform-shaped cross-sections of the sub-wavelength structures during optimization.

8. The method of claim 6, further comprising suppressing formation of smaller-sized regions during optimization.

9. A method of computer-aided design in accordance with claim 6, wherein steps (d) through (i) are repeated one or more times for different starting array layouts during optimization.

10. A method of computer-aided design in accordance with claim 6, wherein sub-wavelength structures failing to satisfy the manufacturability requirements are excluded from the array layouts.

11. A grating that includes sub-wavelength structures for diffracting incident light and having an operating wavelength, comprising:
a plurality of arrays, each of the arrays in the plurality of arrays having a length and a width, each of said lengths corresponding to a grating periodicity along a first direction and each of said widths corresponding to an array periodicity in an orthogonal direction, each of the arrays including a plurality of sub-wavelength structures being laterally separated from one another and disposed on a supporting substrate, at least some of said sub-wavelength structures having freeform-shaped cross-sections;
wherein the arrays in the plurality of arrays are arranged in a repeating pattern in said first direction and in said orthogonal direction;
wherein layouts and geometrical shapes of the sub-wavelength structures within the arrays are selected to jointly produce a closest match to a required output energy distribution from the grating; and
wherein the length of the arrays defines a period of the grating.

12. The grating in accordance with claim 11, wherein said required output energy distribution diffracts a majority of the incident light into a 1^{st} diffraction order.

13. The grating in accordance with claim 11, wherein the sub-wavelength structures within said arrays are spaced at non-equal distances from each other.

14. The grating in accordance with claim 11, wherein the sub-wavelength structures within the arrays have heights that are selected to produce a closest match to the required energy distributions from the grating.

15. The grating in accordance with claim 11, wherein gaps between the sub-wavelength structures and minimum dimensions of the sub-wavelength structures within the arrays are constrained to be at or above minimum feature sizes supported by fabrication processes used to produce the sub-wavelength structures.

16. The grating in accordance with claim 11, wherein said arrays contain some sub-wavelength structures that are offset from a remainder of the sub-wavelength structures within the arrays in a direction orthogonal to the grating period.

17. A diffraction grating formed in accordance with the method of claim 1.

18. A diffraction grating formed in accordance with the method of claim 6.
